(19) United States
(12) Patent Application Publication
(10) Pub. No.: US 2026/0249651 A1
(43) Pub. Date: Aug. 27, 2026

(54) TIRE HAVING A TREAD THAT IS FORMED IN FULL OR IN PART FROM A COMPOSITE MATERIAL OF UNITARY MOLDED CONSTRUCTION

(71) Applicant: DECATHLON, VILLENEUVE D'ASCQ (FR)

(72) Inventors: Vincent VENTENAT, VILLENEUVE D’ASCQ (FR); Batel GOSSET, VILLENEUVE D’ASCQ (FR); Kubat NARYNBEK ULU, VILLENEUVE D’ASCQ (FR)

(21) Appl. No.: 19/150,968

(22) PCT Filed: Jan. 25, 2024
(86) PCT No.: PCT/EP2024/051818

§ 371 Date: Jul. 25, 2025

(30) Foreign Application Priority Data
Jan. 26, 2023 (FR) FR2300749

(51) Int. Cl. B60C 11/00; B29D 30/52; B60C 1/00

(52) U.S. Cl. CPC B60C 11/0008; B29D 30/52; B60C 1/0016

(57) ABSTRACT

A tire comprising a tread comprising a main composite material which is of unitary molded construction and which comprises a thermoplastic polymer matrix and a textile reinforcement assembly. The main composite material may form at least 80% by mass of the tread. The textile reinforcement assembly may comprise at least two textile layers.

This application claims the benefit of and is a National Phase Entry of International Application No. PCT/EP2024/051818, which claims benefit of FR2300749, the contents of each of which are incorporated by reference in their entirety.

### TECHNICAL FIELD

The present disclosure concerns the technical field of tires for vehicles, for example tires for cycles. A tire conventionally comprises a carcass having two free longitudinal edges, each reinforced by a bead wire element. The carcass supports a tread for coming into contact with the ground. Sidewalls connected to the tread extend on either side of the tread.

The grip of the tire on the ground, its resistance to puncture and abrasion, its weight and its ability to absorb vibrations during riding depend directly on the material of which it is composed. In particular, the tread of a tire must meet strict constraints in order to guarantee the comfort and safety of the vehicle user.

### PRIOR ART

The treads of traditional tires, especially those of cycle tires, are essentially made of a composite material comprising vulcanized rubber and nylon fibers. Rubber gives the tread its properties of gripping the ground and also effectively absorbs the vibrations experienced by the tread of the tire during rolling, ensuring the comfort of the user. This composite material provides resistance to the tire and ensures a good performance, i.e. a good return of the energy input, for example by the cyclist user, in riding conditions.

A disadvantage of these traditional tires is that vulcanized rubber is not recyclable or difficult to recycle as it cannot be melted and its manufacture is irreversible. The rubber of known tires, especially bicycle tires, is commonly embedded in the composite layer from which it is very difficult to extract it. It is especially difficult to separate nylon from vulcanized rubber. Therefore, the recycling of traditional tires is very complex and is generally not considered due to the high processing costs. Thus, current tires, and especially cycle tires, are destroyed after use and have a very strong environmental impact.

DISCLOSURE

An object of the present disclosure is to propose a tire overcoming the above-mentioned disadvantages and especially having a reduced environmental impact, and capable of being recycled.

To do this, the disclosure relates, according to a first aspect, to a tire comprising a tread characterized in that said tread comprises a main composite material which is of unitary molded construction and which comprises a thermoplastic polymer matrix and a textile reinforcement assembly.

Advantageously, the tire according to a first aspect of the disclosure is capable of being obtained by the method of manufacturing a tire according to a second aspect of the disclosure.

The tread is the part of the tire intended to come into contact with the ground. It preferably has a thickness comprised between 1 and 3 millimeters. The tread advantageously has a width comprised between 18 and 120 millimeters. The tread may have reliefs to improve its grip and performance.

The tire advantageously comprises a carcass supporting the tread.

The tire is preferably a cycle tire. Cycle means a vehicle weighing less than 100 kilograms with one, two or three wheels, for example a bicycle or scooter.

The tire is preferably a bicycle tire.

Compared to a car tire, the tread of a cycle tire has a reduced thickness, preferably substantially half as thick as the tread thickness of a car tire. In addition, the tread width of a cycle tire is smaller, preferably between 2 and 10 times, than the tread width of a car tire.

Preferably, the tread and/or the carcass and/or the tire and/or the multilayer assembly and/or the composite material described in the present text comprises (especially each) a first free longitudinal edge (in particularly substantially annular), and optionally a second free longitudinal edge (in particular substantially annular).

Preferably, the tread and/or the carcass and/or the tire and/or the multilayer assembly and/or the composite material described in the present text comprise (especially each) a first end and a second end, free or integral with each other, and disposed between said first and second free longitudinal edges.

“Main composite material” is understood to mean a material comprising at least two components of different natures, in particular comprising a main thermoplastic matrix and a textile reinforcement assembly, and optionally one or more non-textile elements, optionally one or more non-textile reinforcement elements. In particular, said textile reinforcement assembly, and optionally the non-textile element(s), is/are embedded in the main thermoplastic matrix.

The main composite material is preferably obtained by thermocompressing a multilayer assembly comprising a hot-meltable textile part (in particular forming a hot-melted textile part in the tire) and a non-hot-meltable textile part (in particular forming a non-hot-melted textile part in the tire), and optionally one or more non-hot-meltable non-textile elements (for example, a reinforcing fiberglass rod) and one or more hot-meltable non-textile elements (for example, a thermoplastic polymer film).

In one embodiment, the main composite material comprises:
one or more non-textile, non-hot-meltable elements (for example, reinforcing fiberglass rod); and/or
one or more non-textile, hot-meltable elements (for example, thermoplastic polymer film).

Textile is understood in the present text to mean any element/component/tube/part/portion/structure obtained by the manipulation, especially mechanical manipulation, of at least one fiber and/or of at least one yarn, or at least one set of fibers.

Advantageously, the hot-melted textile part, and optionally one or more hot-melted non-textile elements, form the main thermoplastic matrix.

Advantageously, the non-hot-meltable textile part forms the textile reinforcement assembly.

Advantageously, the textile reinforcement assembly comprises one or more textile reinforcement elements, in particular the said textile reinforcement element(s) may be chosen from: a woven fabric, a knitted fabric, a nonwoven fabric (for example a spunbond nonwoven fabric, a meltblown nonwoven fabric, or a combination of these), one or more yarns, a braid, a sheet of optionally carded and/or needled fibers, any element obtained by the manipulation of at least one yarn and/or at least one fiber, and a mixture of these, preferably a knit, more preferably a tubular knit. “Unitary molded construction” is understood to mean any composite material obtained by molding at least one hot-meltable textile part, and at least one non-hot-meltable textile part, and optionally at least one non-textile non-hot-meltable part (for example a reinforcing fiberglass rod) and/or at least one non-textile hot-meltable part (for example a thermoplastic polymer film), disposed in a molding assembly, in a single step comprising the application of heat and pressure to melt or soften the hot-meltable part(s).

Preferably, “non-hot-meltable textile part” or “non-hot-meltable non-textile part” is understood in the present text to mean any textile part, or any non-textile part, which is not intended to be hot melted, that is to say which is not intended to be melted or softened, during the method for manufacturing a tire according to the disclosure, and therefore in the tire obtained.

The thermoplastic polymer matrix according to the disclosure may comprise one or more thermoplastic polymers, for example of different natures. The thermoplastic polymer matrix comprises, for example, polypropylene (PP) or thermoplastic polyurethane (TPU) or even a mixture of these. In a non-limiting manner, said polymers may be of different colors.

In the present text, thermoplastic is understood to mean any material capable of melting or being softened by heating in order to form it, and this can be done several times.

In particular, a thermosetting or non-thermoplastic material cannot be softened sufficiently by heating to be shaped several times.

The thermoplastic polymer matrix constitutes a binding layer, within which is disposed said one textile reinforcement assembly, and optionally one or more non-hot-meltable non-textile elements. The thermoplastic polymer matrix ensures the transfer of the forces experienced by the tread to the textile reinforcement assembly.

Advantageously, in the present text, “non-hot-meltable” means any element/component/portion/structure or any part which is not configured to be in a hot-melted state in the tire (i.e. during the thermocompression step for manufacturing the tire), this element/component/portion/structure or part may be partially or totally thermoplastic, or be partially or totally non-thermoplastic, preferably is thermoplastic, but the highest heating temperature applied in the tire manufacturing method according to the disclosure is lower than the melting (or degradation) temperature of said element/component/portion/structure or said part.

Preferably, the thermoplastic polymer matrix comprises one or more hot-melted textile elements, even more preferably consists essentially of one or more hot-meltable textile elements.

Preferably, at least 50% by mass or at least 60% by mass or at least 70% by mass or at least 80% by mass or at least 90% by mass or at least approximately 95% by mass of the thermoplastic matrix is formed of one or more hot-melted textile elements and/or one or more hot-melted films. The tread preferably comprises one or more reinforcement elements, including at least one textile reinforcement element.

The textile reinforcement element is advantageously a non-hot-meltable textile part, and optionally thermoplastic.

Preferably, but in a non-limiting manner, the tread has an internal face and the textile reinforcement element is located on said internal face of the tread.

Preferably, the textile reinforcement element comprises one or more yarns. More preferably, the textile reinforcement element comprises one or more knitted yarns.

Preferably, the textile reinforcement assembly comprises one or more textile reinforcement element(s) which is/are each a textile tubular element, or a textile layer, especially knitted or braided or woven, more preferably said knitted tubular element, or said knitted layer, comprises weft stitches (also called weft knit in the state of the art) or warp stitches (also called warp knit in the state of the art).

Preferably, the textile reinforcement assembly comprises one or more tubular textile elements, especially knitted or woven or braided, optionally substantially flattened, or one or more textile tube portions, especially knitted or woven or braided, optionally substantially flattened, each especially comprising first and second longitudinal edges, especially substantially annular in shape.

Preferably, a textile tube portion (for example, a first or second textile tube portion), optionally flattened, or a textile tubular element, optionally flattened, comprises:
a first longitudinal edge coinciding with, or overlapping with, the first free longitudinal edge of the tread and/or carcass and/or tire; and/or
a second longitudinal edge coinciding with, or overlapping with, the second free longitudinal edge of the tread and/or carcass and/or tire. Preferably, a textile tube portion (for example a first or second textile tube portion), optionally flattened, or a textile tubular element, optionally flattened, comprises superimposed first and second textile layers.

Preferably, the first longitudinal edge, respectively the second longitudinal edge, of the composite material or of the multilayer assembly described below coincide(s) with or overlap(s) the first longitudinal edge, respectively the second longitudinal edge, of the carcass or tire or tread.

Preferably, said tubular knitted element is knitted on a circular knitting machine, in particular of small diameter called a sock knitting machine, or alternatively a flat knitting machine with a double bed.

Said at least one textile reinforcement element imparts to the tread a high resistance, especially resistance to abrasion and to the shear forces undergone by the tread during rolling. Said at least one textile reinforcement element furthermore ensures the grip of the tread to the surface, especially to the ground, on which said tread rolls.

The tire according to the disclosure therefore has technical properties, in particular properties of gripping the ground, resistance to abrasion and to shear forces, absorption of shocks and vibrations, similar to those of a traditional tire made of vulcanized rubber.

The tire according to the disclosure has a weight substantially similar to that of a traditional tire, of the same size, but formed of a composite material based on vulcanized rubber and nylon. In other words, the use of a main composite material comprising a thermoplastic polymer matrix and at least one textile reinforcement element according to the disclosure does not significantly increase the weight of the tread and therefore of the tire.

The main composite material forming at least part of the tread of the tire according to the disclosure furthermore makes the tire much more recyclable than traditional tires whose tread is formed of vulcanized rubber and nylon.

In fact, since the polymer matrix is thermoplastic, it can be softened or melted by heating it to a temperature above a threshold temperature, for example a melting temperature. The manufacture of the polymer matrix is therefore reversible and allows recycling of said thermoplastic polymer matrix. In other words, by heating the tire, possibly after milling, it is possible to recycle the thermoplastic polymer matrix in combination with the textile reinforcement assembly to produce new tires or tire component(s) for example. In addition, the thermoplastic polymer material forming the thermoplastic polymer matrix and the textile reinforcement assembly can easily be separated from each other by heating the tread.

In addition, since the reinforcement assembly is textile, it is also particularly recyclable. Also, the entire composite material is particularly recyclable so that the part of the tread formed by the main composite material can be easily recycled.

The tire according to the disclosure is therefore highly recyclable and its environmental impact is greatly reduced.

The tread preferably consists essentially of the main composite material so as to be substantially entirely recyclable.

In a preferred embodiment, the main composite material of unitary molded construction consists essentially of a thermoplastic polymer matrix, and of a textile reinforcement assembly, in particular of at least one textile reinforcement element, and optionally of one or more non-textile elements.

Preferably, it is understood in the present text that the main composite material consists essentially of a thermoplastic polymer matrix, and of a textile reinforcement assembly, that the thermoplastic polymer matrix and said textile reinforcement assembly are, considered together, predominant by mass or by volume in said main composite material, preferably that said thermoplastic matrix and said textile reinforcement assembly represent at least 50% by mass or by volume, still more preferably at least 60% or at least 70% or at least 80% or at least 90% or at least 95% by mass or by volume, of the main composite material.

In the present text, “at least partially” for an object means substantially the whole of that object or only a part of that object.

In a preferred embodiment, the main composite material represents at least 60% by volume or by mass, preferably at least 70% by volume or by mass, more preferably at least 80% by volume or by mass, preferentially at least 90% by volume or by mass, in particular at least 95% by volume or by mass, more particularly approximately 100% by volume or by mass, of the tread.

The main composite material preferably comprises one or more reinforcement elements including one or more textile reinforcement elements. In other words, without exceeding the scope of the disclosure, the main composite material may comprise one or more reinforcement elements which are not textile.

Without exceeding the scope of the disclosure, the thermoplastic polymer matrix may comprise one or more thermoplastic (co)(ter)polymers chosen from: polyolefins, thermoplastic styrene elastomers, thermoplastic olefine elastomers, polyurethanes, in particular polyurethane elastomers, polyamides, polyesters, and a mixture of these, preferably polyurethanes.

Advantageously, the polyolefins are chosen from: polypropylene, polyethylene, high density polyethylene and very high density polyethylene.

Advantageously, the thermoplastic styrene elastomers are chosen from thermoplastic elastomers comprising styrene repeat units (TPE-S) (in particular a styrene group: CH(C₆H₅)—CH₂), more preferably among the thermoplastic elastomers comprising one or more styrene blocks and optionally one or more olefin blocks (optionally grafted), preferentially among poly(styrene-ethylene-butylene-styrene) (SEBS); poly(styrene-butadiene-styrene) (SBS); poly(styrene-butadiene) (SBC); poly(styrene-isoprene-styrene) (SIS); poly(styrene-ethylene-propylene-styrene) (SEPS), for example marketed under the brand name Septon SEPS® by the company Kuraray, or Kraton GR by the company Kraton.

Advantageously, the thermoplastic olefine elastomers are chosen from:
polyisobutylenes (PIB); and/or
terpolymers of ethylene, propylene and diene (EPDM); copolymers of ethylene and propylene; copolymers of ethylene and alpha-olefin(s), for example copolymers of ethylene and butene or copolymers of ethylene and octene, and a mixture of these; preferably EPDM and copolymers of ethylene and propylene; and/or
mixtures of a polyolefin, in particular polypropylene, with one or more unvulcanized thermoplastic olefine elastomer(s), and optionally one or more plasticizers (for example mineral or naphthenic or paraffinic oil(s)), said thermoplastic olefine elastomer(s) may be copolymers of ethylene and propylene, terpolymers of ethylene, propylene and diene, copolymers of ethylene and alpha-olefin(s) (for example copolymers of ethylene and butene or copolymers of ethylene and octene).

Advantageously, the polyesters are chosen from polyethylene terephthalate and polybutylene terephthalate.

Advantageously, the polyamides are chosen from PA 6, PA 66 and PA 4-6.

Advantageously, the polyurethanes also comprise polyurethane elastomers.

Advantageously, the thermoplastic polymer matrix essentially consists of one or more hot-melted polymer(s).

“Essentially consists of” is understood to mean that the hot-melted polymer(s) represent(s) at least 80% by mass, preferably at least 90% by mass, more preferably approximately 100% by mass, of the thermoplastic polymer matrix.

In a variant embodiment, the main composite material forms at least 80% by mass of the tread. Preferably, the main composite material forms at least 90% by mass, in particular at least 95% by mass, more particularly approximately 100% by mass, of the tread. An advantage is that the tread is formed predominantly, more particularly entirely, of recyclable material, thus improving the recyclability of the tire and further reducing its environmental impact.

In a variant embodiment, the textile reinforcement assembly comprises at least two textile layers.

In a non-limiting manner, a first layer may be hot-meltable while the second layer is non-hot-meltable. Alternatively, each of the two textile layers may be partially hot-melt, and optionally each of the two layers may comprise a non-hot-meltable part.

In a variant embodiment, the main composite material comprises at least a first textile layer, a second textile layer, a third textile layer and a fourth textile layer.

Preferably, at least one of said textile layers is partially hot-meltable. Preferably, at least one of said textile layers has a hot-melt part and a non-hot-melt part.

Alternatively, and without exceeding the scope of the disclosure, one or more of the said textile layers could be entirely hot-melt while the other textile layer or layers is/are not hot-melt.

The presence of these four textile layers improves the grip and resistance of the tire.

In a non-limiting manner, the main composite material may further comprise a fifth textile layer and a sixth textile layer.

In one embodiment, each of said textile layers comprises at least one hot-melt portion and at least one non-hot-meltable portion.

In a variant embodiment, said textile reinforcement assembly comprises a first textile tube portion, the first textile tube portion comprising said first and second textile layers, and said textile reinforcement assembly further comprises a second textile tube portion, the second tube portion comprising said third and fourth textile layers.

An advantage is that the manufacture of each of the tube portions makes it possible to create two textile layers, which facilitates the manufacturing method, especially by avoiding errors in the superimposition of the layers on one another.

In a variant embodiment, said textile reinforcement assembly comprises a first knitted, woven or braided tube portion, the first tube portion comprising said first and second textile layers, and said textile reinforcement assembly further comprises a second knitted, woven or braided tube portion, the second tube portion comprising said third and fourth textile layers.

Advantageously, the first textile tube portion is flattened so that two superimposed textile layers are obtained, formed by the first and second textile layers. Preferably, the second textile tube portion is flattened so that two superimposed textile layers are obtained, formed by the third and fourth textile layers.

In a non-limiting manner, the first and second tube portions may be distinct from each other.

Preferably, at least one of the first and second tube portions is knitted round on a circular knitting machine, in particular of small diameter, or on a flat knitting machine comprising two needle beds.

In a non-limiting manner, the first tube portion may be obtained by knitting a strip whose longitudinal edges are joined together, for example by a longitudinal seam. Alternatively, and preferably, the first textile tube portion may be knitted in a circular manner, in which case it is not necessary to close said first tube portion longitudinally. In a variant embodiment, said first and second tube portions are disposed one above the other or disposed one inside the other.

One advantage is to be able to position the four layers more easily and more precisely with regard to one another and, furthermore, to be able to carry out a more precise zoning on the tread.

In the present text, zoning is understood to mean any modification of at least one textile parameter in one or more regions of the textile tubular portion (also referred to in the present text as a textile tube portion), in particular knitted, said at least one parameter is chosen from: the type of yarn (composition, fineness, partially or not at all hot-melt, color, transparency) and the binding point (stitch pattern).

In the embodiment where the first and second tube portions are disposed one above the other, the first and second textile layers are successive textile layers while the third and fourth textile layers are successive textile layers.

In the embodiment where the first and second tube portions are disposed one inside the other, the second tube portion is preferably disposed inside the first tube portion. In this case, the third and fourth textile layers extend between the first and second textile layers. The first and second tube portions are substantially coaxial.

Alternatively, and in a non-limiting manner, the first tube portion may be disposed inside the second tube portion, in which case the first and second textile layers extend between the third and fourth textile layers.

In a variant embodiment, said textile reinforcement assembly comprises a first textile reinforcement element comprising a first textile zone and a second textile zone in textile connection with the first textile zone, especially by knitting; said first textile zone differs from said second textile zone by at least one property chosen from: the stitch pattern (for example presence of looped sponge-type stitches or woven floats or stitch lines inclined relative to the longitudinal axis of the first textile reinforcement element), the number of yarn(s), the nature of the yarn(s), the mass fraction in the hot-melted textile part (especially the mass fraction in hot-melt textile part), the mass fraction in non-hot-melted textile part (especially the mass fraction in the non-hot-meltable textile part) or the fineness (dtex) of the yarn(s).

Advantageously, the first knitted zone differs from the second knitted zone by at least one property which will impact, for example, the mechanical behavior.

For example, the first knitted zone comprises an elastic yarn while the second knitted zone does not comprise an elastic yarn.

For example, the second knitted zone comprises a mass proportion of at least partially hot-melt yarn(s) greater than the mass proportion of at least partially hot-melt yarn(s) of the first knitted zone.

In a variant embodiment, the first and second textile layers are in a first textile reinforcement element of unitary textile construction, and the third and fourth textile layers are in a second textile reinforcement element of unitary textile construction.

It is understood that the first, respectively third, textile layer and the second, respectively fourth, textile layer are of unitary textile construction so that they are in textile connection, especially in knitted connection, in particular that they are in the same textile piece and contiguous obtained at the outlet of a textile loom, in particular a knitting loom, more particularly without an additional step for its manufacture with the exception of the finishing of its edges and/or the embroidery of at least one elongated element. This definition applies advantageously to any layer/element/piece of unitary textile construction in this text.

In other words, the first and second textile layers are in the same textile piece. The first and second textile layers are interconnected by at least one yarn knitted or woven into both the first textile layer and the second textile layer. Similarly, the third and fourth textile layers are in the same textile piece. The third and fourth textile layers are interconnected by at least one yarn knitted or woven into both the first textile layer and the second textile layer.

In a non-limiting manner, said first and second layers may be successive layers, for example superimposed layers, or else layers spaced apart from each other, separated by other layers.

Preferably, said first, second, third and fourth textile layers are at least partially superimposed on one another.

In a variant embodiment, the first, second, third and fourth textile layers are in a first textile reinforcement element of unitary textile construction.

More preferably, the main composite material comprises a tube comprising said first and second tube portions.

In a first embodiment, said tube is folded back on itself so as to place said first and second tube portions one above the other. In this embodiment, the first and second tube portions are connected to each other by a fold.

In another embodiment, said tube is folded back on itself so as to place the second tube portion inside the first tube portion.

In a variant embodiment, the main composite material comprises at least one intermediate thermoplastic polymer layer, said intermediate thermoplastic polymer layer being disposed between two adjacent textile layers.

Said intermediate thermoplastic polymer layer is configured to partially form the thermoplastic polymer matrix. This intermediate thermoplastic polymer layer improves the impermeability and puncture resistance of the tread.

The intermediate thermoplastic polymer layer advantageously has the form of a hot-melted polymer sheet (especially hot-melt before its thermocompression).

Advantageously, an intermediate thermoplastic polymer layer may be disposed between two superimposed tube portions, and/or between the first and second textile layers, and/or between the third and fourth textile layers, and/or between the first and third textile layers (when the first and second tube portions are coaxial), and/or between the fourth and second textile layers (when the first and second tube portions are coaxial).

In a variant embodiment, the main composite material comprises at least one outer thermoplastic polymer layer, said outer thermoplastic polymer layer being disposed in an outer part of the tread intended to come into contact with the ground.

Said outer thermoplastic polymer layer is intended to come into contact with the ground. Said outer thermoplastic polymer layer forms a wear layer for the tread.

Said hot-melted thermoplastic outer polymer sheet improves the grip of the tread to the ground as well as the abrasion resistance of the tread.

The outer thermoplastic polymer layer advantageously has the form of an at least partially or entirely hot-melted polymer sheet.

In a variant embodiment, the main composite material comprises at least one substantially continuous or discontinuous outer polymer coating, especially at least partially or entirely thermoplastic, said outer polymer coating being disposed in an outer part of the tread intended to come into contact with the ground.

Said outer polymer coating may advantageously form a wear layer for the tread.

Said outer polymer coating may include a base surface from which first recessed patterns project inwardly from the base surface and second patterns in the form of projections outwardly from the base surface, preferably the first and second patterns alternate.

Said coating can be applied by applying at least one liquid composition as described below.

Preferably, said coating comprises a polyurethane, especially a polyurethane elastomer.

In a variant embodiment, the mass fraction of thermoplastic material(s) in the main composite material is greater than or equal to 80%, preferably greater than or equal to 90%, more preferably greater than or equal to 95%, in particular approximately 100%.

This arrangement promotes the ability of the tire to be recycled. In fact, the thermoplastic materials can be shaped several times by heating.

In a variant embodiment, the mass fraction of the thermoplastic polymer matrix in the main composite material is greater than or equal to 50%, preferably greater than or equal to 60%, more preferably greater than or equal to 70%, more preferably greater than or equal to 80%.

In one embodiment, the mass fraction of the thermoplastic polymer matrix in the main composite material is less than or equal to 90%, preferably less than or equal to 85%. By mass fraction of the polymer matrix in the main composite material is understood the ratio of the total mass of the polymer(s) (in particular hot-melted) forming the thermoplastic polymer matrix to the total mass of the main composite material of unitary molded construction.

In a variant embodiment, the mass fraction of the textile reinforcement assembly, in particular of textile reinforcement element(s), in the composite material is less than or equal to 50%, preferably less than or equal to 40%, in particular less than or equal to 30%, preferentially greater than or equal to 5% and less than or equal to 20%, even more preferentially greater than or equal to 10% and less than or equal to 15%.

Preferably, the textile reinforcement assembly forms a textile reinforcement skeleton, more preferably partially thermoplastic or entirely thermoplastic and/or not hot-melted.

In a variant embodiment, the thermoplastic polymer matrix comprises polyurethane, in particular predominantly comprises polyurethane by mass.

In a variant embodiment, the mass fraction of polyurethane(s), especially thermoplastic(s), in the main composite material is greater than or equal to 5%, preferably greater than or equal to 10%, more preferably greater than or equal to 20%, preferentially greater than or equal to 30%, in particular greater than or equal to 40%, more particularly greater than or equal to 50%.

In a variant embodiment, the mass fraction of polyurethane(s), especially thermoplastic(s), in the main composite material is less than or equal to 90%, preferably less than or equal to 80%, more preferably less than or equal to 70%.

In a variant embodiment, the mass fraction of thermoplastic material(s) in said textile reinforcement assembly is greater than or equal to 60% or to 70% or to 80% (optionally less than or equal to 90%), preferably greater than or equal to 90%, even more preferably greater than or equal to 95%, in particular approximately 100%.

This arrangement promotes the ability of the tire to be recycled. In fact, the thermoplastic materials can be shaped several times by heating.

In a variant embodiment, the main composite material, preferably the thermoplastic polymer matrix, comprises a first part comprising a first esthetic property chosen from a first color and a first design, and a second part comprising a second esthetic property chosen from a second color and a second design, the first esthetic property being different from the second esthetic property.

Preferably, the first and second colors are not black.

Patterns and inscription(s) can therefore be formed on the tread.

Preferably, the tread comprises a plurality of substantially similar patterns spaced along the length of the tread.

Preferably, the main composite material, preferably the thermoplastic polymer matrix, comprises a first portion comprising a first relief, and a second portion comprising a second relief different from the first relief.

Said first and second reliefs are advantageously independent of the color of the thermoplastic polymer matrix.

Preferably, the main composite material comprises a first textile reinforcement element in a first color and a second textile reinforcement element in a second color, the second color being different from the first color.

In a variant embodiment, the main composite material, preferably the thermoplastic polymer matrix, comprises a transparent or translucent part forming a viewing window through which at least a portion of the textile reinforcement assembly is visible from outside the tire.

In a variant embodiment, the main composite material, preferably the thermoplastic polymer matrix, comprises at least one light-reflecting pattern.

In a variant embodiment, said textile reinforcement assembly comprises one or more yarns comprising at least one material chosen from: polyesters, especially high tenacity polyesters; polyamides; aramids; polyolefins; celluloses; glasses, or a mixture of these.

In a variant embodiment, said at least one textile reinforcement assembly comprises, in particular, the textile reinforcement element(s) (each) comprise, one or more yarns in at least one material chosen from: polyesters, especially high tenacity polyesters; polyamides; aramids; polyolefins; glasses, or a mixture of these; preferably polyesters; especially high tenacity polyesters; polyamides; polyolefins; or a mixture of these.

Advantageously, the polyesters may be chosen from polyethylene terephthalate (PET), and polybutylene terephthalate (PBT), polytrimethylene terephthalate (PTT), or a mixture of these, preferably polyethylene terephthalate PET.

Advantageously, the polyolefins may be chosen from polypropylene, polyethylene, a copolymer of ethylene and propylene, high density polyethylene (such as UHMWPE), preferably polypropylene and polyethylene, especially high density or very high density polyethylene (e.g. Dyneema).

Advantageously, the polyamides may be chosen from: PA 6, PA 6-6, PA 4-6, PA 11 or 12, or a mixture of these, preferably PA 6 or PA 6-6.

Advantageously, the aramids are chosen from meta-aramids and para-aramids. Aramids are not preferred in the context of the present disclosure because they are not thermoplastic.

Preferably, said textile reinforcement assembly comprises one or more textile reinforcement elements comprising, in particular (each) consisting of, one or more yarns chosen from the preceding list.

Preferably, said textile reinforcement assembly comprises several yarns, said yarns possibly being of the same nature or of different natures.

In a variant embodiment, the main composite material comprises one or more at least partially hot-melted yarn(s).

In the present text, the at least partially hot-melted yarn(s) may be (each) completely melted or partially melted.

The at least partially hot-melted yarn(s) is/are at least partially hot-melt yarns before being transformed in the method for manufacturing a tire according to the disclosure, in particular described below according to a second aspect of the disclosure.

In the present text, said at least partially hot-melt yarn(s) can (each) be entirely hot-melt or partially hot-melt.

An at least partially hot-melted yarn may be a core spun yarn. Preferably, a core spun yarn comprises a core having a melting or softening temperature T1, and a sheath having a melting or softening temperature T2, T1 being greater than T2. Advantageously, the sheath is configured to melt/soften at a temperature T2 which is lower than the core melting/softening temperature T1 during manufacture of the tire.

An at least partially hot-melted yarn may be a yarn of the side-by-side type, a first side is formed of a material having the melting or softening temperature T1 as defined above, and a second side is formed of a material having the melting or softening temperature T2 as defined above.

In particular, the first side and the second side are disposed longitudinally along the length of the yarn.

Therefore, in the main composite material, the sheath or the second side of such a yarn is melted into the thermoplastic polymer matrix while the core or the first side forms at least partially the textile reinforcement element.

An at least partially hot-melted yarn may be a yarn entirely or partially made of a hot-melt material, i.e., having a melting or softening temperature lower than the thermocompression temperature used for the manufacture of the tire according to the disclosure.

In this case, the hot-melt yarn entirely or partially forms at least part of the thermoplastic polymer matrix of the main composite material.

In a variant embodiment, the main composite material comprises, in particular, the textile reinforcement element(s) (each) comprise one or more at least partially non-hot-meltable yarns.

Advantageously, the at least partially non-hot-melted yarn(s) may be (each) entirely non-hot-melted or partially hot-melted.

Advantageously, the non-hot-melted part of an at least partially non-hot-melted yarn, forms a textile reinforcement yarn, i.e., an elongated textile reinforcement element.

Advantageously, the textile reinforcement assembly comprises one or more tubular knits each comprising one or more partially non-hot-melted yarns and/or one or more non-hot-melted yarns.

In a variant embodiment, the main composite material comprises one or more yarns of the core spun type, (each) comprising a metal core and a sheath comprising at least one thermoplastic polymer material, in particular hot-melted (especially hot-melt in the tire manufacturing method), for example made of polyurethane.

This arrangement makes it possible to significantly improve the resistance of the tire. Another advantage is that the metal core can be easily extracted from the used tire and recovered separately from the rest of the tire, before recycling the tire. This facilitates recycling the remaining tire.

In a variant embodiment, the tread, in particular at least one textile reinforcement element, comprises at least one knitted pattern, for example chevrons. Preferably, the knitted patterns extend along a longitudinal direction (Lbr) of the tread, in particular said knitted reinforcing element, and repeatedly over a portion of the length of the tread or said knitted reinforcing element, or over the entire length of the tread or said knitted reinforcing element.

The knitted patterns may also extend into a first sidewall and/or into a second sidewall (as described below). In this case, preferably, the tread and the first sidewall, and optionally the second sidewall, are each formed at least partially, especially entirely, of the main composite material.

In a variant, the tread comprises a longitudinal direction Lbr, and the main composite material, in particular at least one textile reinforcement element, comprises knitted stitches disposed along lines of knitted stitches and comprising one or more reinforcing yarns, at least one (or each) of said lines of knitted stitches having a longitudinal direction Lmt, the direction Lmt intersecting with the longitudinal direction Lbr.

Advantageously, the main composite material, in particular said at least one textile reinforcement element, comprises a longitudinal direction Lmc substantially parallel to the longitudinal direction Lbr of the tread.

Advantageously, the longitudinal direction Lbr of the tread, respectively the longitudinal direction Lmc of the main composite material, extends along the general circumferential direction of the tire.

Advantageously, the longitudinal direction Lmt forms with the longitudinal direction Lbr an angle β1 greater than 0° and less than or equal to 90°, in particular less than or equal to 60°, more particularly less than or equal to 50°.

Advantageously, β1 is greater than or equal to 10°, in particular greater than or equal to 20°, more particularly greater than or equal to 30°.

Said knitted stitches disposed along knitted stitch lines may also extend in a first sidewall and/or in a second sidewall (as described below). In this case, preferably, the tread and the first sidewall, and optionally the second sidewall, are each formed at least partially of the main composite material.

In a variant embodiment, said tire further comprises at least one sidewall, and said main composite material forms at least partially, especially entirely, said at least one sidewall. One advantage is to also improve the recyclability of the sidewall and therefore more generally of the tire.

Said sidewall and said tread are preferably of unitary molded construction.

The tire preferably comprises a first sidewall and a second sidewall, said sidewalls extending on either side of the tread.

Preferably, the main composite material at least partially forms the first sidewall, and at least partially forms the second sidewall, more preferably the main composite material forms the first and second sidewalls and the tread.

The first and second sidewalls and said tread are preferably of unitary molded construction, especially in said main composite material.

Preferably, the tread and the sidewall comprise at least one yarn in common, preferably a knitted yarn.

In a variant embodiment, the mass fraction of the textile reinforcement assembly in the tread is greater, in particular by at least two or three times, than the mass fraction of the textile reinforcement assembly in said at least one sidewall. One advantage is to improve the tread strength, especially abrasion and impact resistance, while reducing the weight of the tire. Indeed, the sidewalls are not intended to come into contact with the ground much, if at all, so that they are less subject to the stresses of gripping and abrasion resistance.

By mass fraction (%) of the textile reinforcement assembly in the tread, respectively a sidewall, is understood the ratio of the total mass of the textile reinforcement assembly in said tread, respectively said sidewall, to the total mass of the tread, respectively said sidewall; in particular this mass fraction can be calculated over a portion of the length of the tire or over the tire as a whole.

In a variant embodiment, the mass fraction of the textile reinforcement assembly in at least one sidewall, especially the first sidewall and/or the second sidewall, is greater than or equal to 20%, preferably greater than or equal to 30%, more preferably greater than or equal to 40%, preferentially less than or equal to 80%, especially less than or equal to 70% or 60%.

In a variant embodiment, the mass fraction of the textile reinforcement assembly in the tread is less than or equal to 45%, in particular less than or equal to 30%, more particularly less than or equal to 20%.

In a variant embodiment, the mass fraction of the thermoplastic polymer matrix in the tread is greater, in particular by at least two or three times, than the mass fraction of thermoplastic polymer matrix in a sidewall, in particular a first or second sidewall.

Advantageously, a sidewall has the function of enabling the tire to be secured to a wheel and does not come into direct contact with the ground so that less textile reinforcement is necessary.

Advantageously, it is possible in the present disclosure to adjust the mass fraction of thermoplastic polymer matrix and the mass fraction of textile reinforcement independently of each other in the tire, in particular between the tread and at least one sidewall, by varying the mass fractions of hot-melted textile portion(s) and of non-hot-melted textile portion(s).

In a variant embodiment, the mass fraction of the thermoplastic polymer matrix in the tread is greater than or equal to 30%, preferably greater than or equal to 50%, more preferably greater than or equal to 60%.

In a variant embodiment, the mass fraction of the thermoplastic polymer matrix in said at least one sidewall, in particular in the first sidewall and/or the second sidewall, is greater than or equal to 5%, preferably greater than or equal to 20%, more preferably greater than or equal to 30%, in particular less than or equal to 60%.

In a variant embodiment, the tread comprises at least one textile reinforcement element ERBR and said at least one sidewall comprises at least one textile reinforcement element ERPF different from said textile reinforcement element ERBR of the tread.

The textile reinforcement element ERPF advantageously has a different linear density (dtex), especially two to three times lower, than the linear density of the textile reinforcement element ERBR.

The textile reinforcement element ERBR and the textile reinforcement element ERPF preferably comprise (or are) one or more yarns of a different nature. For example, the textile reinforcement element ERBR may comprise (or be) polyamide yarn(s) while the textile reinforcement element ERPF comprises (or is) polyester yarn(s).

In a variant embodiment, the mass per unit area (g/m²) of said at least one sidewall is less than the mass per unit area (g/m²) of the tread. One advantage is to increase the resistance to puncture of the tread while limiting the weight of the sidewall and therefore of the tire.

In a variant embodiment, the mass fraction of textile reinforcement(s) in said at least one sidewall is greater than the mass fraction of textile reinforcement(s) in said tread.

In a variant embodiment, said tire comprises two left and right free longitudinal edges, at least one of said two left and right free longitudinal edges comprises a bead wire element, and said main composite material at least partially, especially entirely, forms said bead wire element.

In one embodiment, the thermoplastic polymer matrix forms at least 50% by volume or by mass of said bead wire element, in particular at least 80% by volume or by mass of said bead wire element.

One advantage is to further improve the recyclability of the tire compared to traditional tires whose bead wires are metal and must be extracted before recycling the tire. Furthermore, it will be understood that the bead wires and the tread are in a unitary molded construction, so that the manufacture of the tire is facilitated.

In a variant embodiment, the tire comprises at most 10% by mass of vulcanized rubber(s) and/or one or more thermosetting polymers, optionally vulcanized. One advantage is to reduce the amount of material that is poorly recyclable or not recyclable within the tire, in order to further improve the recyclability of the tire.

Preferably, the tire comprises at most 5% by mass of vulcanized rubber(s) and/or of one or more thermosetting polymers, optionally vulcanized.

More preferably, the tread and/or the main composite material and/or the tire do not comprise vulcanized rubber(s) and/or thermosetting polymer(s), optionally vulcanized.

When the tread and/or the main composite material and/or the tire comprise one or more vulcanized rubbers and/or one or more thermosetting polymers, optionally vulcanized, this or these polymers represent at most 10% by mass of the total mass of the tire, in particular at most 5% by mass of the total mass of the tire.

In a variant embodiment, the tread comprises at least 50%, preferably at least 60%, more preferably at least 70%, preferentially at least 80%, by mass of polyurethane(s), in particular thermoplastic polyurethane(s).

In a variant embodiment, at least 50% by mass, preferably at least 60% or 70% or 80% by mass, of the thermoplastic polymer matrix of the main composite material consists of one or more hot-melted thermoplastic polyurethane(s) and optionally said main composite material comprises one or more textile reinforcement elements, in particular non-hot-melted, based on polyurethane(s).

The present disclosure also relates, according to a second aspect, to a method for manufacturing at least a part of a tire, in particular a tire, especially as described above with reference to the first aspect of the disclosure, comprising the steps of:
a) preparing a multilayer assembly comprising at least one hot-melt textile part, especially during thermocompression step b), and at least one non-hot-meltable textile part, especially during thermocompression step b);
b) thermocompressing said multilayer assembly with a mold configured to mold at least part of the tread of a tire, especially the tread or said tire, by heating said multilayer assembly so as to melt said hot-melt textile part, especially so as not to melt the non-hot-meltable textile part;
c) obtaining a main composite material of unitary molded construction comprising a thermoplastic polymer matrix and a textile reinforcement assembly, said composite material at least partially forming the tread of a tire, especially forming said tread and/or said tire.

Thermocompression causes the melting and/or softening of the hot-melt textile part of the multilayer assembly so that the hot-melt textile part melted by thermocompression forms at least part of the thermoplastic polymer matrix of the composite material obtained.

The non-hot-meltable textile part does not melt during thermocompression, so that the non-hot-meltable textile part at least partially forms the textile reinforcement assembly of the main composite material obtained.

Advantageously, the textile reinforcement assembly comprises said at least one non-hot-meltable and/or non-hot-melted textile part, optionally at least partially thermoplastic, or thermoplastic.

Preferably, the multilayer assembly comprises at least one first textile layer which is partially hot-melt, and optionally a second textile layer, especially at least partially hot-melt.

In one embodiment, the multilayer assembly results from the use of elements (optionally polymer film or metal wire for example) and/or solid and/or dry textile layer(s). There are no liquid resins or solvents used.

Advantageously, the multilayer assembly has the general shape of a strip comprising two free or joined ends, in particular joined together, to form a torus, for example the free ends are joined together by a seam.

Advantageously, the multilayer assembly comprises a strip, in particular has the form of a strip, and said strip has first and second free ends between which the longitudinal direction of said multilayer assembly extends, and a first lateral edge, in particular also designated in the present text first longitudinal edge, and a second lateral edge, also designated in the present text second longitudinal edge, between which the transverse direction of said multilayer assembly extends. Advantageously, the transverse direction of said multilayer assembly is substantially perpendicular to the longitudinal direction of said multilayer assembly.

Advantageously, the length of the strip-shaped multilayer assembly corresponds to the distance between the first and second free ends, or ends joined together, of the multilayer assembly.

Advantageously, the width of the strip-shaped multilayer assembly corresponds to the distance between the first and second lateral (or longitudinal) edges.

Advantageously, the longitudinal direction of the multilayer assembly extends along the general circumferential direction of the tire (or torus).

Advantageously, the multilayer assembly comprises an inner surface and an outer surface, in particular the outer surface is intended to come into contact with the ground and the inner surface is opposite the outer surface, the inner surface is especially facing the carcass of the tire.

Preferably, the first textile layer is oriented directly toward the outer surface of the multilayer assembly.

Preferably, the multilayer assembly comprises one or more textile layers, especially knitted or woven or braided, and/or one or more textile tube portions, especially knitted or woven or braided, optionally substantially flattened, comprising, especially each, first and second longitudinal edges, especially each substantially annular in shape.

Preferably, a textile tube portion (for example a first or second textile tube portion), optionally flattened, or a textile layer (e.g. first/second/third/fourth textile layer), comprises a first longitudinal edge coinciding with, or overlapping with, the first free longitudinal edge of the tread and/or of the carcass and/or of the tire and/or of the composite material.

Preferably, a textile tube portion (for example a first or second textile tube portion), optionally flattened, or a textile layer (e.g. first/second/third/fourth textile layer), comprises a second longitudinal edge coinciding with, or overlapping with, the second free longitudinal edge of the tread and/or of the carcass and/or of the tire and/or of the composite material.

Preferably, a textile tube portion, optionally flattened, or a textile tubular element, optionally flattened, comprises two superimposed textile layers, such as the first and second textile layers or the third and fourth textile layers described in the present text.

Said textile layer (e.g. the first/second/third/fourth textile layer(s)) may also comprise a textile part which is thermoplastic and therefore intrinsically hot-melt but which is not intended to be hot-melted/softened during thermocompression step b). This type of textile material is not considered to be hot-melt in the context of the present disclosure (referred to herein as a non-hot-meltable textile portion/part).

Advantageously, a non-hot-meltable portion/part (e.g. textile or not) in the present text (whether for the first, second, third, fourth or fifth aspect of the disclosure) is a portion/part (e.g. textile or not) which is not intended to be hot-melted in the thermocompression step b), and/or having a melting and/or softening or degradation temperature (e.g.: if non-thermoplastic) greater than or equal to the highest heating temperature applied during the thermocompression step b) and/or used in the tire manufacturing method. Advantageously, a hot-melt portion/part (e.g. textile or not) in the present text (whether for the first, second, third, fourth or fifth aspect of the disclosure) is a portion/part (e.g. textile or not) intended to be hot-melted in the thermocompression step b), and/or having a melting and/or softening temperature less than or equal to the heating temperature, especially the highest, applied during the thermocompression step b) and/or used in the tire manufacturing method.

The multilayer assembly in the present text may comprise first and second textile layers, in particular comprises a first textile tube portion (especially woven or knitted or braided) comprising said first and second textile layers (especially knitted), and optionally third and fourth textile layers, more particularly also comprises a second textile tube portion (especially woven or knitted or braided) comprising said third and fourth textile layers (especially knitted).

The first and second textile tube portions may be two distinct textile tubes, or they may be in the same textile tube folded back on itself or for which a tube portion is inserted into the internal volume of the remaining tube portion.

In a variant embodiment, step a) comprises the preparation of a multilayer assembly comprising a first textile layer comprising at least one yarn A which is at least partially hot-melt, a second textile layer comprising at least one yarn B which is at least partially hot-melt, a third textile layer comprising at least one yarn C which is at least partially hot-melt and a fourth textile layer comprising at least one yarn D which is at least partially hot-melt; and step b) comprises thermocompressing the multilayer assembly with a mold configured to mold at least the tread of a tire, by heating said multilayer assembly so as to melt at least partially said yarns A, B, C and D of said first, second, third and fourth textile layers.

The melted part from the yarns A and/or B and/or C and/or D forms, at least partially or entirely, the thermoplastic polymer matrix of the main composite material, while the non-melted part from the yarns A and/or B and/or C and/or D forms, at least partially or entirely, the textile reinforcement assembly of the said main composite material.

Advantageously, said non-melted part, and therefore non-hot-meltable part, as defined in the present text, may be at least partially thermoplastic, or thermoplastic.

A textile layer, whether it is a first, second, third or fourth textile layer, is advantageously at least partially hot-melt, i.e., it can be entirely hot-melt (and therefore hot-melted/softened during step b) in the main composite material) or partially hot-melt (and therefore partially hot-melted/softened during step b) in the main composite material).

In a variant embodiment, the non-hot-meltable textile part comprises a first polyurethane having a melting or softening temperature T3, and the hot-melt textile part comprises a second polyurethane having a melting or softening temperature T4, T3 being greater than T4.

The first polyurethane provides the tread with stiffening properties and improves the tread resistance, especially to puncture, abrasion and deformation. The second polyurethane, once melted, makes it possible to bond the textile reinforcement element(s) comprising the textile reinforcement assembly within the thermoplastic polymer matrix by providing cohesion between these reinforcement elements.

In particular, T4 is higher than the highest heating temperature applied in thermocompression step b) and/or the highest heating temperature applied in the tire manufacturing method.

In particular, T3 is less than or equal to the heating temperature, especially the highest, during thermocompression step b) and/or the highest heating temperature applied in the tire manufacturing method.

In a variant embodiment, the multilayer assembly comprises at least one textile reinforcement element comprising knitted loops or woven floats comprising one or more at least partially hot-melt yarns.

In a variant embodiment, the multilayer assembly is configured so as to obtain, in step c), a main composite material also forming at least part of a sidewall of the tire.

In a variant embodiment, the first and second textile layers are in a first textile element of unitary textile construction, and the third and fourth textile layers are in a second textile element of unitary textile construction.

Advantageously, the multilayer assembly comprises a first textile element of unitary textile construction, said first textile element comprising said first and second textile layers, and a second textile element of unitary textile construction, said second textile element comprising said third and fourth textile layers.

In a variant embodiment, the main composite material, or the multilayer assembly, comprises a first knitted or woven or braided tube portion, the first tube portion comprising said first and second textile layers, and the main composite material, or the multilayer assembly, further comprises a second knitted or woven or braided tube portion, the second tube portion comprising said third and fourth textile layers.

In a preferred embodiment, the first knitted, woven or braided tube portion is in bound by knitting, weaving or braiding with the second knitted, woven or braided tube portion. Preferably, the first knitted tube portion is of unitary knitted construction with the second knitted tube portion.

This arrangement facilitates the correct placement of the first tube portion relative to the second tube portion when they are superimposed to form a torus.

Advantageously, the second textile tube portion is folded over the first textile tube portion or housed inside the internal volume of the first textile tube portion.

In another embodiment, the first tube portion and the second tube portion are respectively first and second textile tubes independent of each other.

In a variant embodiment, the multilayer assembly is heated to a temperature greater than or equal to 100° C. and less than or equal to 250° C. during thermocompression step b).

In a variant embodiment, the multilayer assembly is thermocompressed during step b) by applying a pressure greater than or equal to 1 bar and less than or equal to 200 bar, preferably less than or equal to 150 bar, 100 bar or 50 bar.

In a variant embodiment, the method comprises the application (step e)) using a device for spraying one or more liquid composition(s) onto:
one or more surface portions, especially the inner surface and/or the outer surface, of the multilayer assembly, and/or
one or more surface portions, especially the inner and/or outer surface, the tread and/or the tire,
in particular, the multilayer assembly or the tread or the tire is disposed in a mold or on a conveyor in order to form at least one coating zone, in particular in order to form two or more coating zones, at least one coating zone comprising a physicochemical and/or mechanical characteristic different from a physicochemical and/or mechanical characteristic of the remaining coating zones.

In particular, the physicochemical and/or mechanical characteristics are chosen from: thickness, abrasion resistance, gripping of a surface such as the ground, Shore A or D hardness, the type of liquid composition or applied pattern; more particularly the type of liquid composition varies according to the type of polymer(s), the type of fibers that may be present and the solids content.

Preferably, step e) comprises, after the application of said at least one liquid composition, a drying step during which the solvent (organic or water) of said liquid composition is evaporated to form one or more coating zones.

Preferably, the polymer type is a natural rubber and/or a polyurethane, especially a polyurethane elastomer.

Preferably, the polymer type is a thermoplastic polymer and/or a thermoplastic elastomer.

In one embodiment, the liquid composition comprises at least one polymer dispersed in an organic solvent or in water.

Aqueous dispersions, optionally comprising fibers, are known in the state of the art, such as aqueous polyurethane dispersions.

The solids content of said at least one polymer in the liquid composition may be greater than or equal to 5% or 10% and less than or equal to 60% or 55% or 50%, optionally less than or equal to 30% or 25% or 20%.

The solids content is, for example, greater than or equal to 30% and less than or equal to 50%.

The solids content of the at least one polymer is calculated by relating the total dry mass of the polymer(s) of the liquid composition to the total dry mass of the liquid composition.

The mass fraction of fibers in the liquid composition may be greater than or equal to 5% or to 10% and less than or equal to 30% or to 25% or to 20%.

The mass fraction of fibers is calculated by relating the total mass of fibers to the total mass of the liquid composition.

The liquid composition may comprise fibers, in particular chosen from fibers made of synthetic material(s), in particular polyester fibers (PET, PBT, for example), polyamide fibers (PA 6 or 66, for example), polyurethane fibers, polyolefin fibers (PP, PE, HMWPE, UHMWPE), or a mixture of these; fibers made of natural material(s) (cotton, hemp, flax, etc.); recycled fibers, reinforcing fibers, in particular derived from a mixture of synthetic or natural fibers, such as those named above, or a mixture of these.

Said fibers may be at least partially hot-melt, or at least partially non-hot-meltable (within the meaning of the present text and therefore optionally at least partially thermoplastic).

The liquid composition may be applied to the multilayer assembly, especially substantially flat, for example on a conveyor, or after step d) of gathering on a toroidal mold, before step b) of thermocompression, or optionally after step b) of thermocompression on all or part of the tread and/or of the tire.

The spray device may include one or more spray nozzles. A spray nozzle may spray a liquid composition similar to or different from the liquid composition sprayed by another spray nozzle.

The spray nozzles may apply one or more liquid compositions simultaneously so as to form at least one integrated coating zone, in particular integrated coating zones, i.e., forming a part without demarcation or boundary.

The liquid composition(s) may be applied as described in European Patents EP 2864536, EP 2262632 and EP 1807253.

The descriptions of european patents EP 2864536, EP 2262632 and EP 1807253 are incorporated by reference into the present text.

In a variant embodiment, the multilayer assembly comprises a first textile element, for example a textile layer or a textile layer of a textile tube portion or of a textile tubular element, comprising a first textile zone and a second textile zone in textile connection with the first textile zone, especially by knitting, said first textile zone differs from said second textile zone by at least one property chosen from: the stitch pattern (for example presence of looped sponge-type stitches or woven floats or lines of stitches inclined with regard to the longitudinal axis of the first textile element), the number of yarns, the nature of the yarn(s), the mass fraction of the partially hot-melted textile (especially the mass fraction of the hot-melt textile part), the mass fraction of the non-hot-meltable textile part, or the fineness (dtex) of the yarn(s).

Advantageously, the first knitted zone differs from the second knitted zone by at least one property which will impact, for example, the mechanical behavior.

For example, the first knitted zone comprises an elastic yarn while the second knitted zone does not comprise an elastic yarn.

For example, the second knitted zone comprises a mass proportion of at least partially hot-melt yarn(s) greater than the mass proportion of at least partially hot-melt yarn(s) of the first knitted zone.

In a variant embodiment, the multilayer assembly comprises at least one textile reinforcement element, for example a first textile tube portion and/or a second textile tube portion, said textile reinforcement element comprises at least one knitted pattern, for example knitted chevrons or lines inclined with regard to the longitudinal axis L of the strip and especially parallel to each other.

Preferably, the knitted patterns extend along the longitudinal direction of the multilayer assembly, in particular in the general shape of a strip, and repeatedly over a portion of the length of said knitted reinforcement element, or over the entire length of said knitted reinforcement element.

The knitted patterns may also extend over a portion of the width of said knitted reinforcement element, or over the entire width of said knitted reinforcement element.

Advantageously, the knitted patterns, for example V-shaped or chevrons, or inclined knitted lines, comprise first patterns, for example V-shaped, and second patterns, for example V-shaped, knitted or woven with one or more yarns different from the yarn or yarns of the first patterns, for example V-shaped. The first patterns, for example V-shaped, alternate with the second patterns, for example V-shaped, over at least part of the length of the multilayer assembly.

Advantageously, at least one first pattern, for example V-shaped, or chevron, comprises a mass fraction of hot-melt textile greater than the mass fraction of hot-melt textile of at least one second pattern, for example V-shaped, or chevron. In a variant, the multilayer assembly comprises at least one textile reinforcement element, for example a first textile tube portion and/or a second textile tube portion, comprising knitted stitches with one or more reinforcing yarns, in particular at least partially non-hot-meltable, said knitted stitches being arranged along lines of knitted stitches, at least one of said lines of knitted stitches having a longitudinal direction Lmt, the direction Lmt intersecting with the longitudinal direction of the multilayer assembly.

Advantageously, the knitted stitch lines comprise knitted stitch lines inclined toward the first (longitudinal) side edge or the second (longitudinal) side edge.

Advantageously, the longitudinal direction Lmt forms with the longitudinal direction of the multilayer assembly an angle 31 greater than 0° and less than or equal to 90°, in particular less than or equal to 60°, more particularly less than or equal to 50°.

Advantageously, β1 is greater than or equal to 10°, in particular greater than or equal to 20°, more particularly greater than or equal to 30°.

The knitted stitch lines may also extend over a portion of the width of said knitted reinforcing element, or over the entire width of said knitted reinforcing element.

In a variant, the multilayer assembly forms at least 80% by mass or volume, preferably at least 90% by mass or volume, more preferably approximately 100% by mass or volume, of the tread, in particular of the tread with a first sidewall and/or a second sidewall.

In a variant, the first, and/or second, and/or third, and/or fourth textile layer(s), especially knitted, comprise(s) at least one longitudinal textile region, especially knitted, comprising textile patterns, especially knitted, in particular inclined textile lines, especially knitted, especially along an axis Lmt, with regard to the longitudinal axis L of the strip, and said patterns comprise at least one yarn, especially knitted, at least partially non-hot-meltable, and/or at least one yarn, especially knitted, at least partially hot-melt.

Said at least one longitudinal region extends in particular adjacent to one of the first and second longitudinal edges of the strip and/or of said multilayer assembly, over all or part of the length of the first tube portion and/or of said textile layer.

For example, the surface area (cm²) occupied by said at least one longitudinal region is less than or equal to 60%, especially between 20% and 40%, of the surface area of the targeted textile layer.

For example, the surface area (cm²) occupied by said at least one longitudinal region is greater than or equal to 60%, especially greater than or equal to 80% or 90% or substantially 100%.

For example, the inclination of the textile lines disposed in said at least one longitudinal textile region for a given layer, for example the first or third layer, may be different or similar, for example opposite, to the inclination of the textile lines in said at least one longitudinal textile region for another given layer, for example the second or fourth layer.

Lmt forms an angle with the longitudinal axis L of the strip which may be greater than 0° and less than or equal to 70°, in particular greater than or equal to 30° and less than or equal to 60°, for example around 45°+/−5°.

In a variant embodiment, the first and/or second and/or third and/or fourth textile layer(s), especially knitted, comprises (each comprise) two textile longitudinal regions, especially knitted, extending over all or part of the length of said textile layer, or of the first textile tube portion, especially knitted, one textile longitudinal region comprises textile lines, especially knitted, inclined with regard to the axis L of the strip according to a first inclination, and the other longitudinal textile region comprises textile lines, especially knitted, inclined relative to the axis L of the strip according to a second inclination different from the first inclination.

This arrangement improves the mechanical properties of the tread.

For example, the surface area (cm²) occupied by a textile longitudinal region is between 45% and 65% of the surface area of the targeted textile layer, or between 25% and 35% of the surface area of the targeted textile layer if a third textile longitudinal region is present.

In a variant embodiment, the first, and/or second, and/or third, and/or fourth textile layer(s), especially knitted, comprises (each comprise) at least one textile longitudinal region, especially knitted, comprising textile loops, especially knitted, comprising at least one at least partially hot-melt yarn.

Preferably, this longitudinal textile region is disposed substantially at the center of the first or second textile layer.

Preferably, the surface area (cm²) occupied by said at least one longitudinal region is less than or equal to 60%, especially approximately between 20% and 40%, of the surface area of the targeted textile layer.

In a variant, the first textile layer, especially knitted, of the first textile tube portion, especially knitted, comprises first, second and third longitudinal textile regions, especially knitted, at least one of the first and third longitudinal textile regions comprises textile patterns (in particular textile lines), especially knitted, extending diagonally (e.g. along the axis Lmt defined above) relative to the longitudinal axis L of the strip, and said textile patterns comprise an at least partially non-hot-meltable yarn and/or an at least partially hot-melt yarn, the second longitudinal textile region, arranged between the first and third longitudinal regions, comprises textile loops or elongated textile portions, especially knitted, comprising at least one at least partially hot-melt yarn, and/or
the second textile layer, especially knitted, comprises at least one at least partially hot-melt yarn, especially knitted, so as to extend substantially along the entire width of said second textile layer and substantially at least partially along the entire length of the second layer, and/or
the second textile longitudinal region of the first layer is intended to form at least a portion of the surface of the central zone of the tread of the tire, in particular forms one or more regions of engagement with the ground.

In a variant, the first textile layer of the first textile tube portion comprises first, second and third textile longitudinal regions, especially knitted, the second longitudinal region, disposed between the first and third longitudinal regions, comprises knitted loops comprising at least one at least partially hot-melt yarn, and the total mass fraction of the hot-melt textile part in the second longitudinal region is greater than the total mass fraction of the hot-melt textile part in the first longitudinal region or the total mass fraction of the hot-melt textile part in the third longitudinal region.

Preferably, the second textile longitudinal region of the first layer is intended to form at least a portion of the surface of the central zone of the tread of the tire, in particular forms one or more regions of engagement with the ground.

In a variant embodiment, said at least one textile longitudinal region and/or the first textile longitudinal region and/or the third textile longitudinal region of a textile layer (e.g.: first/second/third/fourth), especially of the first textile layer, comprises/each comprise at least one at least partially hot-melt yarn, especially a polyurethane yarn of 600 denier +/−200 denier, in particular knitted with a plating yarn, more particularly a non-hot-meltable yarn, for example a polyamide yarn. Preferably, the at least partially hot-melt yarn(s) knitted in the first and/or second and/or third longitudinal region(s) is/are made of polyurethane.

In a variant, the third knitted layer and/or the fourth knitted layer each comprise(s) patterns knitted diagonally with regard to the longitudinal axis L of the strip (for example lines knitted diagonally, for example along the axis Lmt), in particular extending substantially over the entire width of the second tube portion, and more particularly substantially over the entire length of the second tube portion.

Preferably, the knitted patterns extend diagonally and form an angle with the longitudinal axis L between 30° and 60°, for example approximately 45°+/−5°.

Preferably, the third and/or fourth layer(s) is/are knitted with at least one at least partially hot-melt yarn, especially a polyurethane monofilament yarn of 600 denier +/−200 denier, with one or more at least partially non-hot-meltable yarn(s), especially one or more plating yarn(s).

In a variant embodiment:
the multilayer assembly comprises a strip comprising two ends joined together to form a torus,
said strip comprises a first longitudinal edge comprising gathers in a first position, and said torus has a circumference C1 in the first position, and
said method comprises a step d), taking place before step b), and optionally after or before step e) of applying by spraying at least one liquid composition, and comprising a step of disposing said torus on a counter-mold in a second position in which at least part of the gathers, in particular substantially all the gathers, are spaced apart from each other, and said torus adopts a circumference C2 greater than C1.

Advantageously, the gathers arranged along the first longitudinal edge make it possible to vary the circumference of the torus between a first position, corresponding to a rest position, and a second position, corresponding to an elongated position in which the gathers are spread apart and the first longitudinal edge is in an extended position.

Advantageously, said strip also comprises a second longitudinal edge comprising, in the first position, gathers, at least some of these gathers, in particular substantially all of these gathers, are spaced apart from one another in the second position.

Advantageously, this arrangement makes it possible to hold the torus in position on the counter-mold, in particular also in the form of a torus, during the thermocompression step b), and optionally during the application step e), without the first longitudinal edge, and especially the second longitudinal edge, moving inadvertently on the counter-mold.

It has been observed that without this arrangement, the first and second longitudinal edges of the strip, and therefore of the torus, are not correctly tensioned on the counter-mold, and that the positioning of the strip on the counter-mold is also not reproducible.

The arrangement of first and second gathered longitudinal edges makes it possible to overcome these problems.

Preferably, the gathers are distributed over at least a part of the length, preferably substantially along the entire length, of the first longitudinal edge.

Preferably, the gathers are distributed over at least a part of the length, preferably substantially along the entire length, of the second longitudinal edge.

Preferably, L2, respectively C2, is greater than L1, respectively C1, by at least 10% or 20%, more preferably by at least 40% or 50%, more preferably by at least 70% or 80%.

Advantageously, said strip has a length L1 in the first position, or the torus has a circumference C1 in the first position, and a length L2 in the second position, or the torus has a circumference C2 in the second position.

Preferably, the length L1 corresponds to the length of the first or second longitudinal edge.

In a variant, said first longitudinal edge, and/or the second longitudinal edge, of the strip comprises (each comprise) one or more elongated gathering elements arranged over all or part of the length of said first longitudinal edge, and/or of said second longitudinal edge, so as to create said gathers, at least one of said elongated elements is a gathering yarn comprising a hot-melt polymer material, in particular a polyurethane.

The gathers may be formed along the first longitudinal edge, and optionally along the second longitudinal edge, by joining together along at least part of the length, in particular substantially over the entire length, of the first longitudinal edge, and optionally of the second longitudinal edge, at least one elongated element (for example an elastic cord) so as to bring portions of the strip closer together and create folds.

In a variant, the first longitudinal edge, and/or the second longitudinal edge, of the strip comprises (each comprise) an elongated gathering element which is a first knitted gathering yarn comprising a hot-melt polymer material, particularly polyurethane, and an elongated gathering element which is a second knitted gathering yarn and comprising floats, optionally comprising a hot-melt polymer material, particularly polyurethane.

Advantageously, a first gathering yarn and a second gathering yarn are knitted along at least part of the length, in particular substantially over the entire length, of the first longitudinal edge, and optionally of the second longitudinal edge, said gathering yarns being knitted so that, in the strip in the first rest position, the first gathering yarn exerts tension at regular intervals on the second gathering yarn, thus bringing portions of the strip closer to one another to create folds.

Advantageously, the first gathering yarn and the second gathering yarn are both knitted on the first and/or second longitudinal edge(s) of the first knitted tubular portion, and optionally on the first and/or second longitudinal edge(s) of the second knitted tubular part.

Advantageously, the width of a fold or gather corresponds to the length of a float.

Advantageously, a knitted float corresponds to a portion of the second gathering yarn extending substantially rectilinearly over a determined number of columns of stitches, in particular without forming looped stitches, and optionally without forming loaded stitches.

Preferably, the first gathering yarn is an at least partially hot-melt yarn (optionally substantially completely), in particular made of polyurethane.

Preferably, the first gathering yarn comprises a hot-melt portion having a melting temperature comprised between 120° C. and 170° C.

Preferably, the first gathering yarn has a tenacity of the order of 1.50 cN/dtex +/−1 cN/dtex.

Preferably, the first gathering yarn has an elongation at break greater than or equal to 10%, in particular less than or equal to 100% or 30%.

Preferably, the first gathering yarn is of the core spun type, with a non-hot-meltable core, and optionally thermoplastic, for example made of polyethylene terephthalate (PET) (or polybutylene terephthalate (PBT)) or polyamide (PA 6 or 6-6), and a hot-melt sheath, for example made of polyurethane, even more preferably the mass fraction of the sheath in the yarn is comprised between 60% and 90%, and the mass fraction in the core is comprised between 10% and 40%.

Preferably, the first gathering yarn is a monofilament yarn, in particular having a diameter greater than or equal to 0.10 mm and less than or equal to 0.60 mm, in particular around 0.35 mm +/- 0.20 mm. Preferably, the second gathering yarn is a multifilament yarn or spun yarn of PET, PBT or polyamide fibers.

Preferably, the second gathering yarn is not a hot-meltable yarn but is optionally thermoplastic.

Advantageously, the first and second gathering yarns are knitted in such a way that, in the first rest position, the first gathering yarn shrinks and thus brings the float portions closer together, thus creating folds or gathers.

In addition to the intrinsic elasticity characteristics of the first gathering yarn, it is also possible to knit it by exerting a high tension in order to amplify its shrinkage in the first position and the formation of gathers.

The characteristics (elongation at break, toughness, etc.) are preferably measured with UNI EN ISO 2062-2010, and the linear density with DIN EN ISO 2060.

The present disclosure also relates, according to a third aspect, to a method for recycling a tire, advantageously comprising:
the collection of at least one tire, especially with reference to the first aspect of the disclosure, or obtained according to the method described with reference to the second aspect of the disclosure;
the milling of at least one tire to obtain milled particles or fragments;
   a step of transformation of said milled particles or fragments into granules which can be transformed by a hot transformation process, for example by extrusion molding, said transformation step comprising an extrusion-granulation step.

The definitions, alternative embodiments and embodiments with reference to the first aspect of the disclosure may be combined with the second aspect or the third aspect or the fourth aspect of the disclosure.

The present disclosure relates, according to a fourth aspect, to a multilayer assembly for manufacturing a tire by thermocompression, in particular for its use in the method of manufacturing a tire according to any one of the alternative embodiments with reference to the second aspect of the disclosure.

The multilayer assembly may comprise any variant, embodiment or definition described with reference to the multilayer assembly in the manufacturing method according to a second aspect of the disclosure, or with reference to the textile reinforcement assembly according to a first aspect of the disclosure.

Advantageously, the multilayer assembly comprises a strip, in particular is in the form of a strip, comprising two free ends or ends joined together, in particular joined together, to form a torus.

Advantageously, said multilayer assembly comprises at least one hot-melt textile part and at least one non-hot-meltable textile part.

Advantageously, said multilayer assembly comprises a first textile tube portion comprising first and second textile layers, and optionally a second textile tube portion comprising third and fourth textile layers, and at least one of the first textile tube portion and optionally of the second textile tube portion comprises at least one hot-melt textile part, especially in the method of manufacturing the tire by thermocompression, and at least one of the first textile tube portion and optionally of the second textile tube portion comprises at least one non-hot-meltable textile part, especially in the method of manufacturing the tire by thermocompression.

Advantageously, said at least one non-hot-meltable textile part is at least partially thermoplastic.

In a variant, the predominant component by mass relative to the total mass of said multilayer assembly is a thermoplastic polyurethane.

The term “predominant component by mass” is understood to mean a component whose mass fraction in said multilayer assembly is the highest, optionally in comparison with the mass fraction(s) in the other component(s) present. This predominant mass fraction may be less than 50%, for example 20% or 30% at least, or may be greater than 50% or 60% or 70% or 80% or 90%.

In a variant embodiment, the mass fraction of thermoplastic material(s) in said multilayer textile assembly is greater than or equal to 60% or to 70% or to 80% (optionally less than or equal to 90%), preferably greater than or equal to 90%, even more preferably greater than or equal to 95%, in particular approximately 100%.

This arrangement promotes the ability of the tire to be recycled. In fact, the thermoplastic materials can be shaped several times by heating.

In a variant, said strip comprises a first longitudinal edge, said first longitudinal edge comprises, in a first position, gathers, and said strip has a total length L1, preferably said torus has a circumference C1, in the first position, and said strip has a length L2, preferably said torus has a circumference C2, in a second position in which at least part of the gathers, in particular substantially all the gathers, are spaced apart, L2 being greater than L1, preferably C2 is greater than C1.

Advantageously, the total length L1 is the distance separating the first and second free or joined ends of the strip.

Advantageously, said strip has a longitudinal axis L extending between its first and second free ends joined together, and a transverse axis T extending substantially perpendicularly to the axis L.

In a variant, said first longitudinal edge comprises one or more elongated gathering elements arranged over all or part of the length of said first longitudinal edge so as to create said gathers, at least one of said elongated elements is a gathering yarn comprising a hot-melt polymer material, in particular a polyurethane, optionally a polyurethane elastomer.

In particular, the (first or second) gathering yarn is a hot-meltable yarn (i.e., intended to be hot melted in the tire manufacturing method according to the disclosure).

Advantageously, the elongated gathering element(s) is/are knitted in at least one of the first and second textile tube portions.

Alternatively, the first longitudinal edge, and optionally the second longitudinal edge, of the strip comprises (each comprise) an elongated gathering element which is a first knitted gathering yarn comprising a hot-meltable polymer material, particularly a polyurethane, and an elongated gathering element which is a second knitted gathering yarn comprising floats.

The multilayer strip or assembly is also as described in the present text, and in particular according to variant embodiments, taken independently of one another, appearing in the description of the method for manufacturing a tire with reference to the second aspect of the disclosure, in particular independently of the steps of said manufacturing method, or again with reference to the tire according to a first aspect of the disclosure.

According to a fifth aspect, the present disclosure also relates to the use of a multilayer assembly for manufacturing a tire by thermocompression, said multilayer assembly being as described in the present text, and in particular according to variant embodiments appearing in the description of the method for manufacturing a tire with reference to the second aspect of the disclosure, in particular independently of the steps of said manufacturing method, and/or appearing in the description of the multilayer assembly with reference to the fourth aspect of the disclosure.

### BRIEF DESCRIPTION OF THE DRAWINGS

The disclosure will be better understood on reading the following description of embodiments of the disclosure given by way of non-limiting examples, with reference to the attached drawings, in which:

FIG. 1 schematically shows a first example of a tire according to the disclosure;

FIG. 2 schematically shows a side view of first example of a multilayer assembly according to the disclosure for manufacturing a tire;

FIG. 3 schematically shows a side view of a second example of a multilayer assembly according to the disclosure for manufacturing a tire;

FIG. 4 schematically shows a side view of a third example of a multilayer assembly according to the disclosure for manufacturing a tire;

FIG. 5 schematically shows a side view of a fourth example of a multilayer assembly according to the disclosure for manufacturing a tire;

FIG. 6 schematically shows a side view of a fifth example of a multilayer assembly according to the disclosure for manufacturing a tire;

FIG. 7 schematically shows a side view of a sixth example of a multilayer assembly according to the disclosure for manufacturing a tire;

FIG. 8 schematically shows a flat view of the arrangement of a textile layer of a textile tube or a textile tube portion according to the disclosure, for example as shown in FIGS. 2 to 7;

FIG. 9 schematically shows a flat view of the first and second textile layers of a second example of a textile tube according to the disclosure;

FIG. 10 schematically shows a flat view of the first textile layer of a fifth example of a textile tube according to the disclosure;

FIG. 11 schematically shows a flat view of a sixth example of a knitted tube according to the disclosure forming all or part of a multilayer assembly according to the disclosure for manufacturing a tire;

FIG. 12 schematically shows, flat and viewed from an outer face, the sixth example of a tube according to FIG. 12 folded in thirds;

FIG. 13 schematically shows, flat and viewed from an outer face, the sixth example of a tube according to FIG. 12 folded in thirds;

FIG. 14 schematically shows, in perspective, the sixth example of a tube according to FIG. 12 folded in thirds and whose ends are joined together to form a torus;

FIG. 15 schematically shows, in perspective, a seventh example of a flattened tube comprising a second textile tube portion intended to be folded back against a textile tube portion in order to form a strip;

FIG. 16 schematically shows, in perspective, the strip of FIG. 15 whose first and second free ends are joined to form a torus;

FIG. 17 schematically shows, in perspective, the strip of FIG. 16 in the first rest position;

FIG. 18 schematically shows, in perspective, the strip of FIGS. 16 and 17 in the second position on a toroidal counter-mold;

FIG. 19 schematically shows, along the sectional plane XIX-XIX of FIG. 18, the elongated strip in the second position.

### Description of the Embodiments

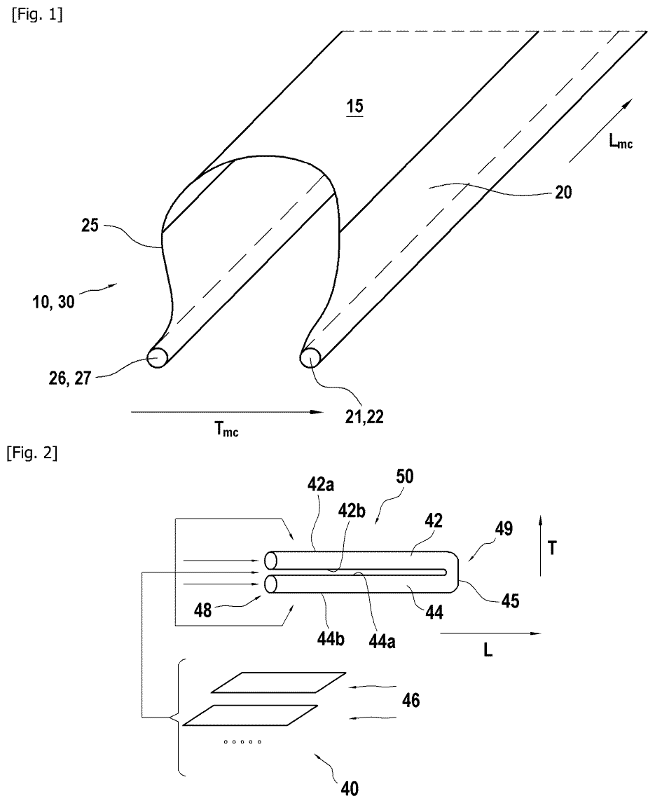

FIG. 1 schematically shows a first example of a tire 10 according to the disclosure comprising a tread 15, a first sidewall 20 and a second sidewall 25. Advantageously, the first and second sidewalls 20, 25 comprise first and second free longitudinal edges 21, 26 reinforced and forming first and second bead wire elements 22, 27. The first and second sidewalls 20, 25 advantageously extend on either side of the tread 15. Advantageously, the tire 10 has the general shape of a torus open longitudinally and extends circumferentially (not shown) according to the intended diameter of the tire 10. Advantageously, the tread 15, the first and second sidewalls 20, 25 and the bead wire elements 22, 27 are of unitary molded construction and are formed from a main composite material 30. The main composite material 30 has a longitudinal axis Lmc, extending circumferentially over the length of the tire 10, and a transverse axis Tmc, substantially perpendicular to the axis Lmc.

FIG. 2 schematically shows a first example of a multilayer assembly 40 according to the disclosure for manufacturing a tire comprising a textile tube 50 folded in half and thus forming a first textile tube portion 42 and a second textile tube portion 44 connected by the fold 45. The first textile tube portion 42 comprises a first textile layer 42a and a second textile layer 42b, the second textile tube portion 44 comprises a third textile layer 44a and a fourth textile layer 44b. The first and/or second and/or third and/or fourth textile layer(s) may (each) comprise one or more fully or partially hot-meltable multifilament and/or monofilament yarn(s) and one or more non-hot-meltable monofilament and/or multifilament yarn(s), in particular the linear density (dtex) and mass fraction of which vary according to the textile layer to be made functional. Preferably, the tube 50 is a tube knitted on a circular knitting machine of small diameter. Advantageously, the stitch pattern of the first knitted layer 42a may be identical to or different from the stitch pattern of the second knitted layer 42b, or else of the third or fourth knitted layer 44a or 44b.

Advantageously, the first tube portion 42 and the second tube portion 44 differ in at least one physical property and/or one chemical property, in particular chosen from: the composition of a yarn, the fineness of a yarn, the mass fraction of hot-meltable textile material and the mass fraction of non-hot-meltable textile material.

The multilayer assembly 40 may also comprise one or more hot-meltable polymer sheets 46, which may be disposed on the external face of the first layer 42a and/or inside the first tube portion 42 and/or between the first tube portion 42 and the second tube portion 44 and/or inside the second tube portion 44 and/or on the external face of the fourth layer 44b. The hot-meltable sheet(s) 46 may be made of at least one polyolefin or a polyolefin elastomer or else polyurethane, for example a polyurethane elastomer. Advantageously, said multilayer assembly 40 is generally shaped into a torus, in particular by securing the free ends 48 and 49 of the tube 50 folded in half, then thermocompressed. Said multilayer assembly 40 advantageously comprises a hot-meltable textile part, and a non-hot-meltable textile part, and optionally a hot-meltable non-textile part formed of the hot-meltable sheet or sheets 46.

Advantageously, the multilayer assembly 40 in the form of a torus is placed in a mold assembly comprising a determined molding volume, then closed hermetically, a pressure or vacuum is applied to the multilayer assembly so as to push/press the assembly against the internal walls of the mold concomitantly with the application of a heating temperature making it possible to melt and/or soften the targeted hot-meltable material of the multilayer assembly 40. The pressure may advantageously be applied by means of a deformable and inflatable bladder disposed inside the shaped torus of the multilayer assembly 40, which is inflated during thermocompression. Thermocompression can also be carried out using a rigid insert, and therefore non-inflatable, such as a counter-mold disposed in the internal volume of the molding assembly. Advantageously, at the end of the thermocompression, a tire is obtained comprising a tread, first and second sidewalls, and possibly bead wire elements.

Advantageously, the arrangement of a sheet 46 in a thermoplastic elastomer in the multilayer assembly 40 so as to form at least part of the outer face of the tread makes it possible to improve the abrasion resistance and the grip of the tread.

The textile tube 50 has a longitudinal axis L, corresponding in this example to the direction of the columns of stitches or warp direction or else to the direction of knitting or weaving, and a transverse axis T, substantially perpendicular to the axis L. The transverse axis T preferably corresponds to the weft direction or to the direction of the rows of stitches.

Advantageously, the textile tube 50 is of unitary textile construction, in particular of unitary knitted construction. The textile tube 50 is thus advantageously obtained at the outlet of a knitting machine without an additional step consisting of attaching another textile insert to the tube 50, except for possibly finishing of the edges of the tube 50 by a seam. The tube portions 42 and 44 thus comprise at least one common yarn, in particular knitted.

Advantageously, the multilayer assembly 40 has the general shape of a strip comprising first and second free ends 48, 49, and a longitudinal axis corresponding to the axis L and a transverse axis corresponding to the axis T.

In the state of the art, the manufacture of a tire comprises many steps: manufacture of the tread by impregnation of a textile support with a rubber, then manufacture of the carcass by coating a textile support with a resin, then assembly of the tread with the carcass during the molding of the carcass and the tread together. The molding also allows vulcanization of the polymer impregnating the tread. Finally, bead wire elements, especially metal elements, are assembled along the free longitudinal edges. In the present disclosure, a main composite material forming the tread, the first and second blanks and optionally the bead wire elements is advantageously obtained from dry material(s) (and therefore without solvent) in a single thermocompression step, and this is obtained from thermoplastic material(s) which can be easily recycled together without separation.

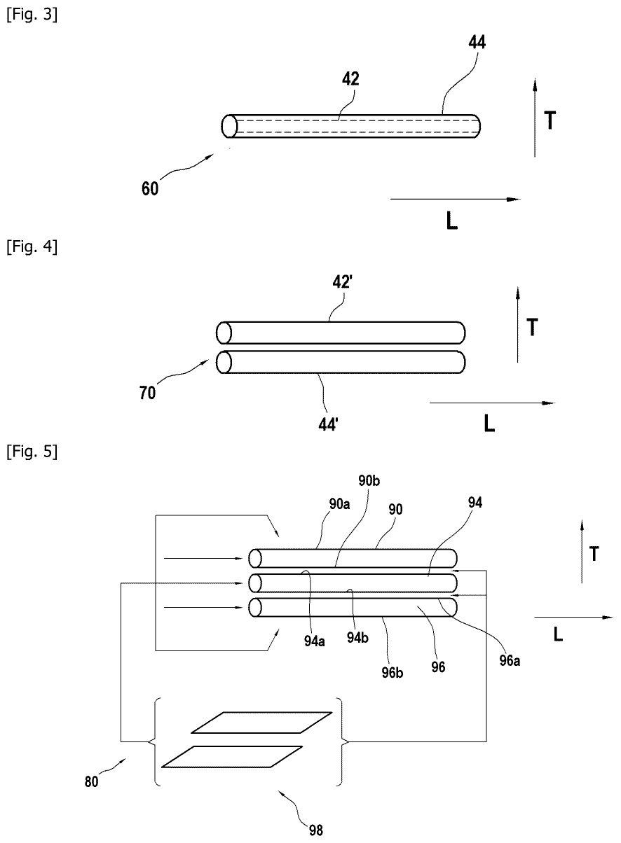

FIG. 3 schematically shows a side view of a second example of a multilayer assembly 60 according to the disclosure for manufacturing a tire which may correspond to the multilayer assembly 40 of FIG. 1 with the difference that the tube portion 42 is inserted into the internal volume of the tube portion 44. In this case, the tube portions 42 and 44 are coaxial in FIG. 3. The tube portions in FIG. 3 are also of unitary textile construction, in particular knitted.

FIG. 4 schematically shows a side view of a third example of a multilayer assembly 70 according to the disclosure for manufacturing a tire which may correspond to the multilayer assembly 60 of FIG. 2 with the difference that the tube portions 42 and 44 are two distinct tubes 42′ and 44′ and are therefore not of unitary textile construction. The tubes 42′ and 44′ are shown superimposed in FIG. 4 but could be arranged coaxially, as shown in FIG. 3.

FIG. 5 schematically represents a side view of a fourth example of a multilayer assembly 80 according to the disclosure for manufacturing a tire comprising three superimposed and distinct tubes 90, 94 and 96. The tubes 90, 94 and 96 are not of unitary textile construction. The tubes 90, 94 and 96 are preferably knitted, in particular on a circular knitting machine. Advantageously, the first tube 90 comprises a first textile layer 90a and a second textile layer 90b, the second tube 94 comprises a third textile layer 94a and a fourth textile layer 94b, and the third tube comprises a fifth textile layer 96a and a sixth textile layer 96b.

Advantageously, the first textile layer 90a and/or the second textile layer 90b and/or the third textile layer 94a and/or the fourth textile layer 94b and/or the fifth textile layer 96a and/or the sixth textile layer 96b may (each) comprise one or more monofilament and/or multifilament at least partially hot-meltable yarns, and one or more monofilament yarns and/or multifilament non-hot-meltable yarns. One or more hot-meltable polymer sheets 98 may be disposed between and/or inside the tubes 90, 94 and 96 and/or on the outer face of the first layer 90a and/or on the outer face of the sixth layer 96b.

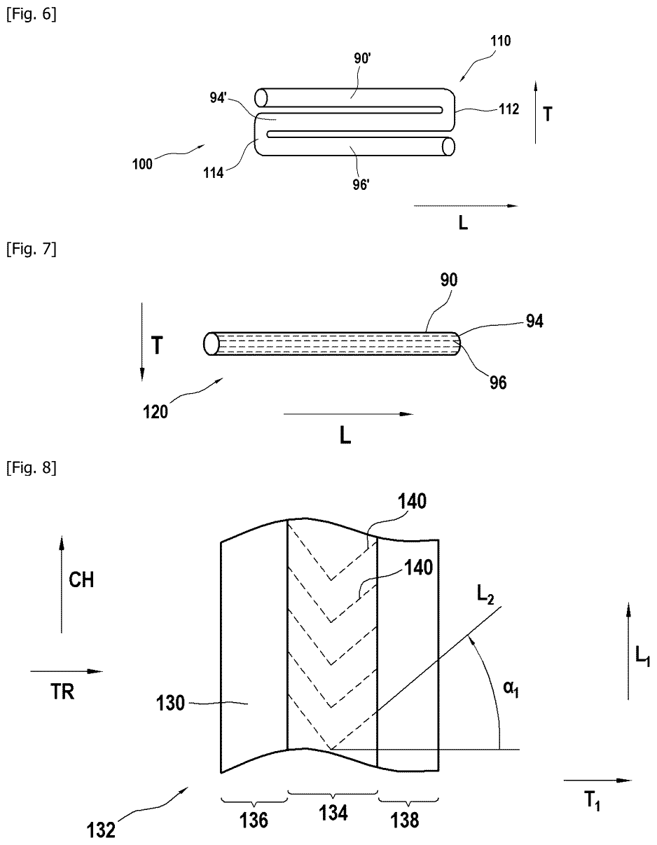

FIG. 6 schematically represents a side view of a fifth example of a multilayer assembly 100 according to the disclosure for manufacturing a tire which may be similar to the multilayer assembly 80 with the difference that the tubes 90, 94 and 96 are tube portions 90′, 94′ and 96′ of unitary textile construction, in particular knitted, and are in a single tube 110. The tube 110 thus advantageously comprises two folds 112 and 114.

FIG. 7 schematically shows a side view of a sixth example of a multilayer assembly 120 according to the disclosure for manufacturing a tire which may be similar to the multilayer assembly 100 except that the tubes 90, 94 and 96 are coaxial. The tube 96 is inserted into the tube 94, and the tubes 94 and 96 are inserted into the tube 90.

FIG. 8 schematically shows, in flat view, an example of a first textile layer 130 of a textile tube or of a portion of tube 132 according to the disclosure. The second textile layer of the tube or of the tube portion 132 may be similar to the first textile layer 130.

The first textile layer 130 advantageously comprises a central zone 134 for the tread, and first and second lateral zones 136, 138 respectively for a first sidewall and a second sidewall.

Advantageously, the first textile layer 130 and the tube portion or tube 132 comprise a longitudinal axis L1 and a transverse axis T1 substantially perpendicular to the axis L1. Advantageously, the central zone of the tread 134 comprises V-shaped or chevron-shaped patterns (or inverted V-shaped patterns, not shown) of knitted stitches or woven floats 140 whose arms are inclined with regard to the longitudinal axis L1, in particular first lateral arms extend in a longitudinal direction L2 forming an angle al with the transverse axis T1 comprised between 15° and 50°. Advantageously, the V-shaped patterns comprise first V-shaped patterns and second V-shaped patterns knitted or woven with one or more yarns different from the yarn or yarns of the first V-shaped patterns. The first V-shaped patterns alternate with the second V-shaped patterns along the length of the central tread zone 134. For example, the first V-shaped patterns are knitted or woven with a composite yarn comprising two polyamide multifilament yarns, especially PA 6, and a polyurethane hot-meltable monofilament yarn, and the second V-shaped patterns are knitted or woven with a composite yarn comprising two polyurethane hot-meltable monofilament yarns and a polyamide multifilament yarn, especially PA 6. Advantageously, a first V-shaped pattern comprises a mass fraction of hot-meltable textile greater than the mass fraction of hot-meltable textile of a second V-shaped pattern. The arrangement of the first and second patterns along the central zone 134 makes it possible to improve the mechanical properties (tensile strength, etc.) of the textile reinforcement in the tire.

Advantageously, the V-shaped or chevron-shaped patterns (or inverted V-shaped patterns, not shown) of knitted stitches or woven floats 140 may extend into the first lateral zone 136, and possibly into the second lateral zone 138.

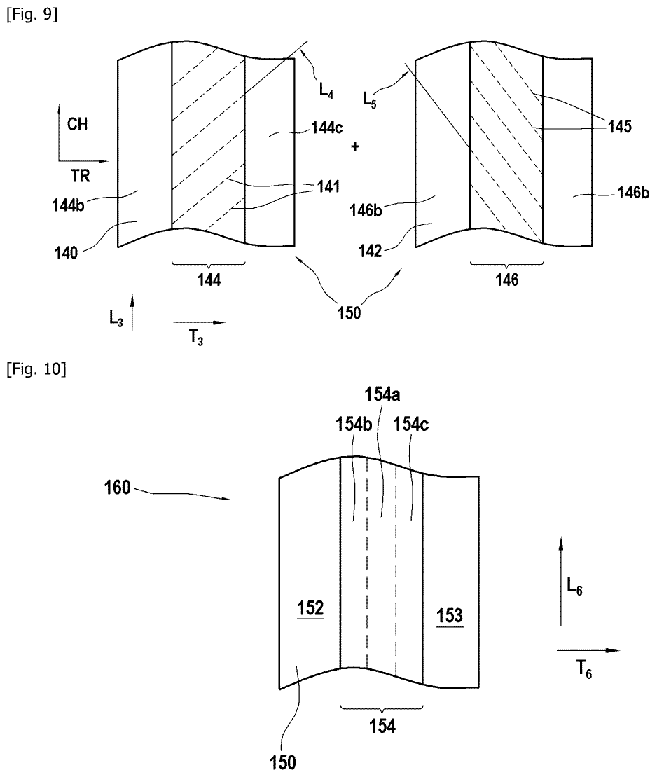

FIG. 9 schematically shows, flat, first and second textile layers 140, 142 of a textile tube portion 147 or of a textile tube 147 having a longitudinal axis L3. Advantageously, the first textile layer 140 comprises lines of knitted stitches or woven floats extending in a first direction L4 and inclined with regard to the axis L3 in the central zone 144 and the second textile layer 142 comprises lines of knitted stitches or woven floats 145 extending in a second direction L5 and inclined with regard to the axis L3 in the central zone 146, the direction L5 being opposite to the direction L4. Advantageously, the stitch lines 145 comprise first and second stitch lines 145, the first stitch lines 145 comprise more non-hot-meltable textile part than the second stitch lines 145. This arrangement makes it possible to orient the textile reinforcement lines in the final composite material and therefore in the tire in order to improve its mechanical properties.

The arrangement of the first and second textile layers 140 and 142 can be repeated for third and fourth textile layers for a second tube portion or a second tube, and possibly in fifth and sixth layers for a third tube portion or a third tube. The first, second or third (portions of) tubes may be arranged as described in the present text, for example they may be superimposed or coaxial. The inclination of knitted stitch lines or woven floats may vary from one textile layer to another depending on the mechanical properties sought for the final textile reinforcement in the main composite material.

Advantageously, the lines of knitted stitches or woven floats 141, respectively 145, may extend into the first lateral zone 144b, respectively 146b, and possibly into the second lateral zone 144c, respectively 146c.

FIG. 10 schematically shows, flat, the first textile layer 150 of an example of a textile tube 160 or of a portion of tube 160 according to the disclosure. The first textile layer 150 comprises a central textile zone 154 intended to form all or part of a tread of a tire according to the disclosure and lateral zones 152, 153 intended to form all or part of the first and second sidewalls respectively of a tire according to the disclosure. Advantageously, the central zone 154 comprises a central sub-zone 154a disposed between first and second lateral sub-zones 154b and 154c. Advantageously, the central sub-zone 154a has a mass fraction of hot-meltable material F1, and the lateral sub-zones 154b and 154c have mass fractions of hot-meltable material F2 and F3 respectively; preferably F1 is greater than F2 or F3, more preferably F1 is greater than at least twice F2 or F3. This arrangement makes it possible to form a longitudinal strip comprising more hot-melted material in the central sub-zone 154a compared with the lateral sub-zones 154b and 154c. In particular, the central sub-zone 154a comprises knitted loops or woven floats projecting from the outer face of the textile layer in order to provide more hot-meltable textile material, for example these are sponge-type stitches (terry loops). The lateral textile zones 152, 153 comprise a mass ratio of hot-meltable textile part to non-hot-meltable textile part ranging from 20:70 to 45:45.

Advantageously, the tube portion or the tube 160 may be associated with the tube portion or the tube 132 or 147, possibly according to the arrangements described in FIGS. 2 to 7 depending on whether the tubes are distinct or whether the tube portions are of unitary textile construction.

In a variant, the central zone 154 may be formed by the central sub-zone 154a, the first lateral zone 152 may be formed by the sub-zone 154b, and the second lateral zone 153 may be formed by the sub-zone 154c.

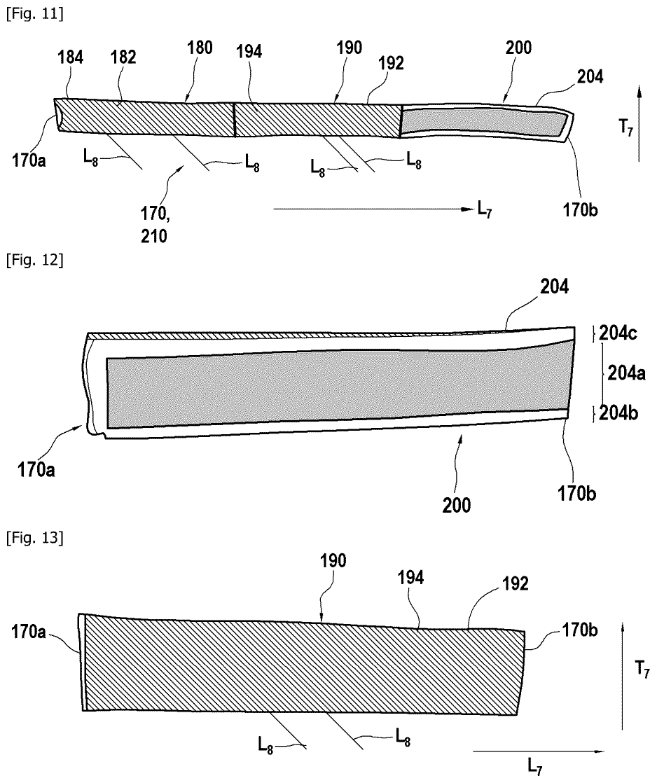

FIG. 11 schematically shows, flat, a sixth example of a knitted tube 170 according to the disclosure intended to form a multilayer assembly according to the disclosure, in whole or only in part, for manufacturing a tire. The knitted tube 170 comprises first, second and third knitted tube portions 180, 190 and 200 which are therefore of unitary knitted construction. Each knitted tube portion 180, 190, 200 comprises two superimposed textile layers.

The knitted tube portion 180 comprises first and second superimposed textile layers 184, the knitted tube portion 190 comprises third and fourth superimposed textile layers 194, and the knitted tube portion 200 comprises fifth and sixth superimposed textile layers 204.

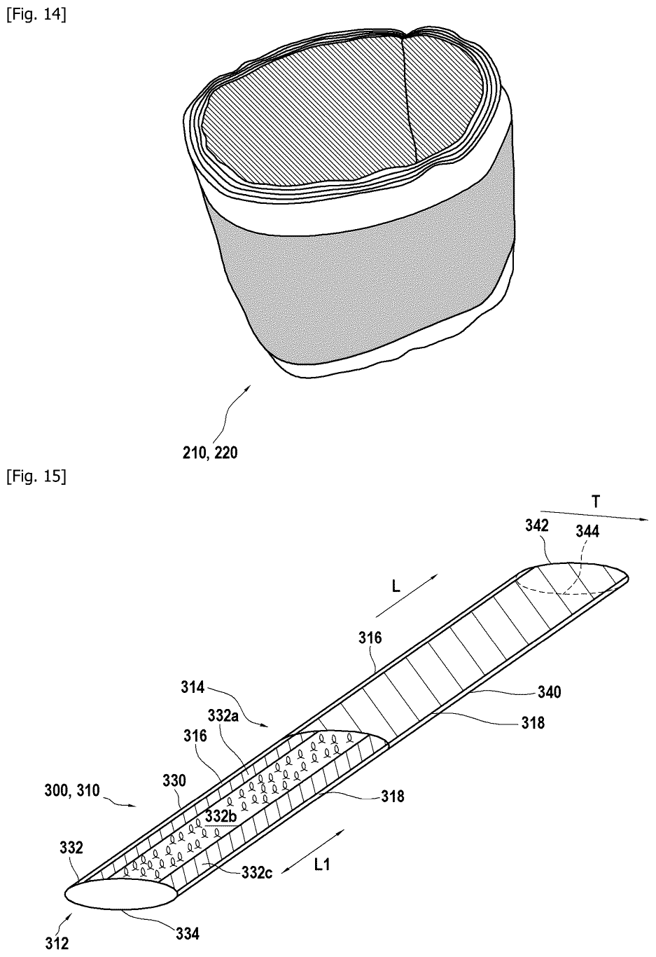

In FIGS. 12, 13 and 14, the tube portions 180, 190 and 200 are superimposed on one another; they could alternatively be arranged so as to be coaxial. The tube 170, thus folded in thirds, advantageously forms a multilayer assembly 210 in which the free ends 170a and 170b of the folded tube 170 are joined together to form a main torus 220. The multilayer assembly 210 thus comprises six superimposed textile layers.

In particular, the first, second, third and fourth textile layers of the tube portions 180, 190 comprise, over their entire width, lines of knitted stitches inclined with regard to the longitudinal axis L7 and extending in a longitudinal direction L8. The composition of said layers is preferably similar to that of the textile central zones 144 and 146 shown in FIG. 9.

The composition of the fifth and sixth textile layers 204 of the tube portion 200 is preferably similar to that of the variant of the textile layer 150 described above with reference to FIG. 10.

The multilayer assembly 210, in the form of a main tube 220, advantageously comprises the fifth textile layer 204 on its outer face so that the central zone 204a forms at least partially the tread of the tire after thermocompression, and the lateral zones 204b and 204c partially form the first and second sidewalls of the tire. Advantageously, the central zone 204 may be similar to the central sub-zone 154a, the lateral zone 204b may be similar to the sub-zone 154b and the lateral zone 204c may be similar to the sub-zone 154c. Advantageously, the multilayer assembly 210 is disposed in a mold assembly comprising a molding insert, inflatable or otherwise, disposed inside the main tube 220. Then, a pressure or vacuum is applied to the molding volume comprising the multilayer assembly 210. The multilayer assembly 210 is heated so as to melt or soften its hot-meltable textile part to form a thermoplastic polymer matrix impregnating the non-hot-meltable textile part, said non-hot-meltable textile part forming the textile reinforcement assembly.

FIGS. 15 to 19 show a seventh example of a multilayer assembly 300 according to the disclosure. Said multilayer assembly 300 comprises, in particular is, a strip 310 comprising first and second free ends 312, 314 which are joined and secured together, to form a torus 320.

The strip 310 comprises a longitudinal axis L extending between its first and second ends 312, 314 and a transverse axis T extending from a first longitudinal edge 316 to a second longitudinal edge 318 and substantially perpendicular to the axis L.

Advantageously, the strip 310 comprises a first textile tube portion 330 and a second textile tube portion 340 folded over the first textile tube portion 330 and in textile connection, especially knitted, with the first tube portion 330.

The first textile tube portion 330 comprises first and second textile layers 332, 334 and the second textile tube portion 340 comprises third and fourth textile layers 342, 344. Advantageously, each of the first 330 and second 340 textile tube portions comprises at least one hot-meltable textile portion and at least one non-hot-meltable textile portion.

Advantageously, each of the first, second, third and fourth textile layers (332, 334, 342, 344) comprises a hot-meltable textile portion and a non-hot-meltable textile portion.

Advantageously, the first textile layer 332 comprises first 332a, second 332b and third 332c longitudinal regions, at least one, preferably each, of the first and third longitudinal regions 332a, 332c comprises knitted patterns extending diagonally with regard to the longitudinal axis L of the strip 310. Alternatively, the first and third longitudinal regions 332a, 332c do not comprise diagonally knitted patterns, and the third and fourth textile layers (342, 344) comprise diagonally knitted patterns extending substantially along the entire width and length of the second knitted tubular portion 340.

The knitted patterns are preferably knitted with at least one yarn that is partially non-hot-meltable, and the diagonal knitted patterns thus provide tensile strength.

Advantageously, the second knitted region 332b, disposed between the first and third knitted regions 332a and 332c, comprises knitted loops at least partially comprising a hot-meltable yarn. Knitted loops make it possible to provide more hot-meltable material and thus to form a tread having an improved grip in the said hot-meltable material(s) used.

Advantageously, the mass fraction of hot-meltable yarn(s), especially polyurethane, in the second longitudinal region 332b is greater than the mass fraction of hot-meltable yarn(s), especially polyurethane, in the first or third longitudinal region(s) 332a, 332c.

Advantageously, the second knitted layer 334 comprises a hot-meltable yarn knitted so as to extend substantially along the entire width of said second layer 334 and substantially at least partially along the entire length of the second layer 334.

Advantageously, the second region 332b of the first layer is intended to form all or part of the tread of the tire, in particular forms one or more regions of engagement with the ground.

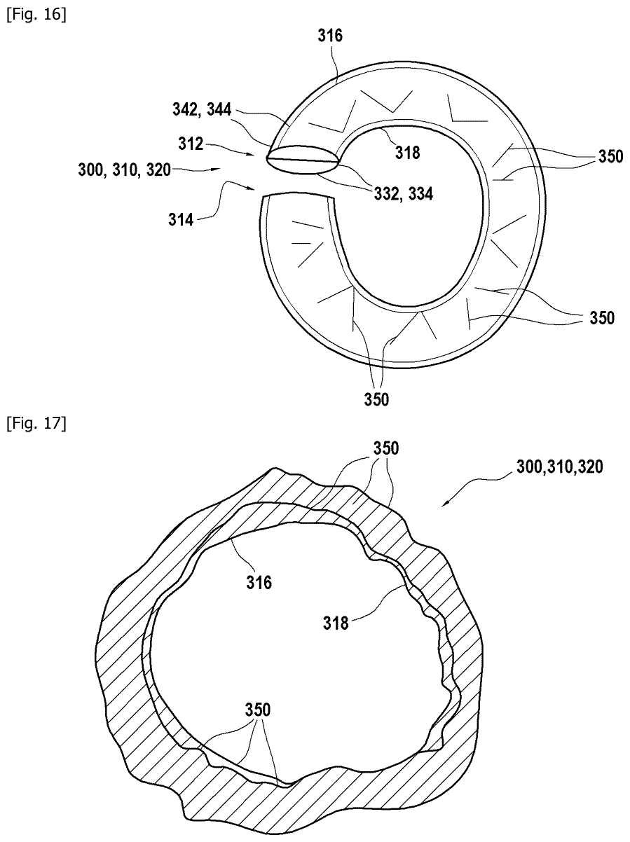

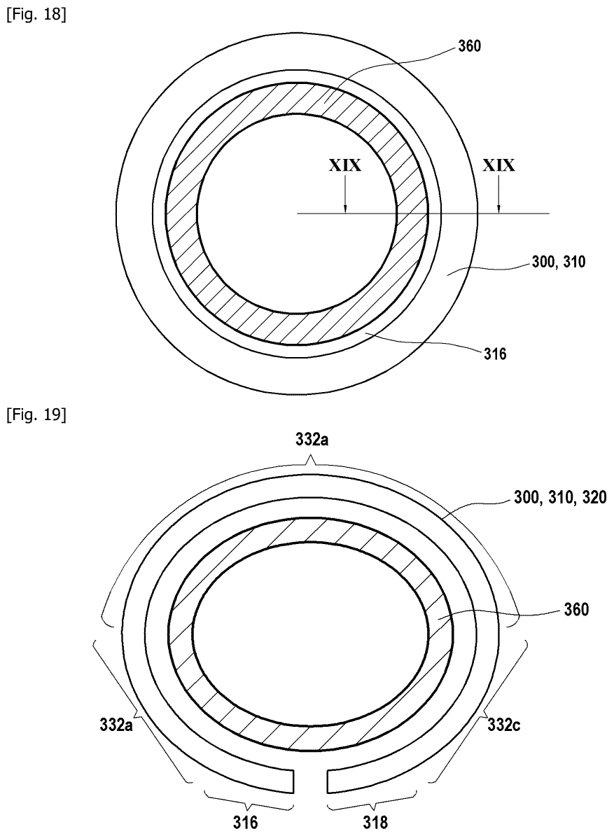

Advantageously, the first longitudinal edge 316 and the second longitudinal edge 318 each comprise, in a first position, gathers 350 as shown in FIGS. 16 and 17. The strip 310 thus has a total length L1, and said torus having a circumference C1, in the first position, and said strip 310 has a length L2, said torus having a circumference C2, in a second position in which at least part of the gathers, in particular substantially all of the gathers 350, are spaced apart from one another, L2 being greater than L1; preferably C2 is greater than C1. The second position is illustrated in FIGS. 18 and 19.

Advantageously, said first and second longitudinal edges 316 and 318 each comprise one or more elongated gathering elements arranged over substantially all their lengths so as to create said gathers 350. In particular, the first and second longitudinal edges 316, 318 each comprise an elongated gathering element which is a first knitted gathering yarn comprising a hot-meltable polymer material, in particular a polyurethane, and an elongated gathering element which is a second knitted gathering yarn and comprising floats. Advantageously, the first gathering yarn is knitted under tension so that, at the outlet of the knitting machine, the first gathering yarn brings the ends of each floats against each other together and thus forms gathers 350 or folds.

The toroid-shaped strip 310 has a circumference C1 in a first reduced rest position, and is then tensioned when it is arranged around a counter-mold 360, especially a toroid-shaped flexible membrane, so as to adopt a circumference C2, greater than C1 as shown in FIGS. 18 and 19.

The first and second longitudinal edges 316, 318 are thus extensible and make it possible to hold the torus 320 in the second position on the counter-mold 360, and make it easier to hold it during the thermocompression step.

Advantageously, the first gathering yarn, and preferably the second gathering yarn, is/are entirely or partially hot-meltable so that it (they) enter(s) into the composition of the polymer matrix, and thus disappear(s) in the tire. Once the thermocompression step has been carried out, when the tire is demolded, the first gathering yarn, and preferably the second gathering yarn, therefore no longer exert(s) tension on the first and second longitudinal edges 316, 318.

1. A tire comprising a tread, wherein said tread comprises a main composite material (30) which is of unitary molded construction and which comprises a thermoplastic polymer matrix and a textile reinforcement assembly.

2. The tire according to claim 1, wherein the main composite material forms at least 80% by mass of the tread.

3. The tire according to claim 1, wherein said textile reinforcement assembly comprises at least two textile layers.

4. The tire according to claim 3, wherein said textile reinforcement assembly comprises at least: a first textile layer a second textile layer, a third textile layer and a fourth textile layer.

5. The tire according to claim 4, wherein said textile reinforcement assembly comprises a first textile tube portion, the first textile tube portion comprising said first and second textile layers, and said textile reinforcement assembly further comprises a second textile tube portion, the second tube portion comprising said third and fourth textile layers.

6. The tire according to claim 5, wherein said first and second tube portions are disposed one above the other or disposed one inside the other.

7. The tire according to claim 4, wherein the first and second textile layers are in a first textile reinforcement element of unitary textile construction, and the third and fourth textile layers are in a second textile reinforcement element of unitary textile construction.

8. The tire according to claim 4, wherein the first, second third and fourth textile layers are in a first textile reinforcement element of unitary textile construction.

9. The tire according to claim 3, wherein the main composite material comprises at least one intermediate thermoplastic polymer layer, said intermediate thermoplastic polymer layer being disposed between two adjacent textile layers.

10. The tire according to any of claim 1, wherein the main composite material (30) comprises at least one outer thermoplastic polymer layer, said outer thermoplastic polymer layer being disposed in an outer part of the tread intended to come into contact with the ground.

11. The tire according to claim 1, wherein the mass fraction of one or more thermoplastic materials in the main composite material is greater than or equal to 80%.

12. The tire according to claim 1, wherein the thermoplastic polymer matrix comprises polyurethane

13. The tire according to claim 1, wherein the main composite material comprises a first part comprising a first esthetic property chosen from a first color and a first design, and a second part comprising a second esthetic property chosen from a second color and a second design, the first esthetic property being different from the second esthetic property.

14. The tire according to claim 1, wherein the main composite material, preferably the comprises a transparent or translucent part forming a viewing window through which at least a portion of the textile reinforcement assembly is visible from outside the tire.

15. The tire according to claim 1, wherein said textile reinforcement assembly comprises one or more yarns comprising at least one material chosen from: polyesters, especially high tenacity polyesters; polyamides; aramids; polyolefins; celluloses; glasses, or a mixture of these.

16. The tire according to any of claim 1, characterized wherein said tire further comprises at least one sidewall and wherein said main composite material at least partially forms said at least one sidewall.

17. The tire according to claim 16, wherein the mass fraction of the textile reinforcement assembly in the tread is greater, than the mass fraction of the textile reinforcement assembly in said at least one sidewall.

18. The tire according to claim 16, wherein the tread comprises at least one textile reinforcement element ERBR, and said at least one sidewall comprises at least one textile reinforcement element ERPF different from said textile reinforcement element ERBR of the tread.

19. The tire according to claim 16, wherein the mass per unit area (g/m²) of said at least one sidewall is less than the mass per unit area (g/m²) of the tread.

20. The tire according to claim 1, wherein said tire comprises two left and right free longitudinal edges, at least one of said two left and right free longitudinal edges comprises a bead wire element, and said main composite material at least partially forms said bead wire element.

21. The tire according to claim 1, wherein the tire comprises at most 10% by mass of vulcanized rubber(s) and/or one or more thermosetting polymers,

22. A method of manufacturing a tire, wherein the method comprises the steps of:
a) preparing a multilayer assembly comprising at least one hot-meltable textile part and at least one non-hot-meltable textile part;
b) thermocompressing said multilayer assembly with a mold configured to at least partially mold a tread of a tire by heating said multilayer assembly to melt said hot-meltable textile part; and
c) obtaining a main composite material of unitary molded construction comprising a thermoplastic polymer matrix and a textile reinforcement assembly, said composite material at least partially forming the tread of a tire.

23. The manufacturing method according to claim 22, wherein step a) comprises the preparation of a multilayer assembly comprising a first textile layer comprising at least one yarn A which is at least partially hot-meltable, a second textile layer comprising at least one yarn B which is at least partially hot-meltable, a third textile layer comprising at least one yarn C which is at least partially hot-meltable and a fourth textile layer comprising at least one yarn D which is at least partially hot-meltable; and wherein step b) comprises thermocompressing the multilayer assembly with a mold configured to mold a tread of a tire, by heating said multilayer assembly so as to at least partially melt said yarns A, B, C and D, of said first, second, third and fourth textile layers.

24. The manufacturing method according to claim 22, wherein the non-hot-meltable textile part comprises a first polyurethane having a melting or softening temperature T3, and the hot-meltable textile part comprises a second polyurethane having a melting or softening temperature T4, T3 being greater than T4.

25. The manufacturing method according to any of claim 22, wherein the multilayer assembly comprises at least one textile reinforcement element comprising knitted loops or woven floats, said knitted loops or said woven floats at least partially comprising hot-meltable yarn(s).

26. The manufacturing method according to any of claim 22, wherein during step c) the multilayer assembly is heated to a temperature greater than or equal to 100° C. and less than or equal to 250° C.

27. The manufacturing method according to claim 22, wherein:
the multilayer assembly comprises a strip comprising two ends joined together to form a torus,
said strip comprises a first longitudinal edge comprising gathers in a first position, and said torus has a circumference C1 in the first position, and
wherein said method comprises a step d), taking place before step b), and comprising a step of disposing said torus on a counter-mold in a second position in which at least part of the gathers are spaced apart from each other, and said torus adopts a circumference C2 greater than C1.

28. The manufacturing method according to claim 27, wherein said first longitudinal edge comprises one or more elongated gathering elements arranged over all or part of the length of said first longitudinal edge so as to create said gathers, at least one of said elongated elements is a gathering yarn comprising a hot-meltable polymer material.

29. The manufacturing method according to claim 28, wherein the first longitudinal edge comprises an elongated gathering element which is a first knitted gathering yarn comprising a hot-meltable polymer material, and an elongated gathering element which is a second knitted gathering yarn and comprising floats.

30. A method of recycling a tire, the method comprising:
milling at least one tire to obtain milled particles or fragments;
transforming the obtained milled particles or fragments into granules for transformation by a transformation process for a heated plastic, said transformation process for heated plastic comprising an extrusion-granulation.

31. A multilayer assembly for the manufacture of a tire by thermocompression, for its use in the manufacturing method according to claim 22, characterized in wherein the multilayer assembly comprises a strip comprising two free ends or joined together to form a torus, wherein said multilayer assembly comprises a hot-meltable textile part.

32. The multilayer assembly for manufacturing a tire by thermocompression according to claim 31, wherein said multilayer assembly comprises a first textile tube portion comprising first and second, textile layers and optionally a second textile tube portion comprising third and fourth textile layers, and wherein at least one of the first textile tube portion and of the second textile tube portion comprises said at least one hot-meltable textile part, and wherein at least one of the first textile tube portion and of the second textile tube portion comprises said at least one non-hot-meltable textile part, at least partially thermoplastic.

33. The multilayer assembly according to claim 31, wherein the component which is predominant by mass relative to the total mass of said multilayer assembly is a thermoplastic polyurethane.

34. The multilayer assembly according to any of claim 31, wherein said strip comprises a first longitudinal edge, said first longitudinal edge comprises, in a first position, gathers, and wherein in said strip has a total length L1, in the first position, and wherein said strip has a length L2, in a second position in which at least part of the gathers are spaced apart, L2 being greater than L1.

35. The multilayer assembly according to claim 34, wherein said first longitudinal edge comprises one or more elongated gathering elements arranged over all or part of the length of said first longitudinal edge so as to create said gathers, at least one of said elongated elements is a gathering yarn comprising a hot-meltable polymer material.

36. The multilayer assembly according to claim 35, wherein the first longitudinal edge comprises an elongated gathering element which is a first knitted gathering yarn comprising a hot-meltable polymer material, and an elongated gathering element which is a second knitted gathering yarn and comprising floats.

37. The multilayer assembly according to claim 31, wherein
the first textile layer of the first textile tube portion comprises first, second and third longitudinal regions, at least one of the first and third longitudinal regions comprises knitted patterns extending diagonally with regard to the longitudinal axis L of the strip, and said knitted patterns each comprise a non-hot meltable yarn, and the second knitted region, disposed between the first and third knitted regions, comprises knitted loops comprising at least partially a hot-meltable yarn,
the second knitted layer comprises a hot-meltable yarn knitted so as to extend substantially along the entire width of said second layer and substantially at least partially along the entire length of the second layer, and
wherein the second region of the first layer is intended to form all or part of the tread of the tire.
